(19) United States
(12) Patent Application Publication
(10) Pub. No.: US 2026/0281805 A1
(43) Pub. Date: Sep. 17, 2026

(54) DYNAMIC BUFFER STATUS REPORTING

(71) Applicant: Dell Products L.P., Round Rock, TX (US)

(72) Inventors: Hemant Kumar Bhawarlal Jain, Bangalore (IN); Vinay Ramdas Revankar, Bengalore (IN)

(21) Appl. No.: 19/079,267

(22) Filed: Mar. 13, 2025

(51) Int. Cl. H04W 28/02; H04W 72/1268; H04W 72/20; H04W 76/28

(52) U.S. Cl. CPC H04W 28/0278; H04W 72/1268; H04W 72/20; H04W 76/28

(57) ABSTRACT

Communication of BSR can be dynamically managed and performed. In response to receiving first BSR, comprising first index, associated with LCG, base station (BS), employing communication manager (CM), can allocate uplink grant to allow device to communicate an amount of data to BS. CM can determine whether BSR value associated with BS-BSR associated with LCG is defined value that can indicate second BSR is to be sent by device. Based on determining BSR value is defined value, CM can determine BSR indicator is to be communicated to device to request device to communicate second BSR to BS. BS can communicate uplink grant and BSR indicator to device. Based on uplink grant and BSR indicator, device can communicate the amount of data and second BSR to BS. If second BSR indicates no additional data available at device, CM can discontinue uplink allocation relating to LCG for device.

### BACKGROUND

Communication networks can enable users to use devices to wirelessly connect to a communication network and communicate with other devices (e.g., wireless devices or other communication devices). A device, such as a mobile device (e.g., smart phone or other mobile wireless device) can connect (e.g., wirelessly connect) to a cell (e.g., cell of a base station) or other access point associated with a radio access network (RAN) to facilitate connection to a communication network. Devices, via connection to the RAN and communication network, can utilize various types of services and applications of or associated with the communication network.

The above-described description is merely intended to provide a contextual overview regarding communication systems, and is not intended to be exhaustive.

### SUMMARY

The following presents a simplified summary in order to provide a basic understanding of some aspects described herein. This summary is not an extensive overview of the disclosed subject matter. It is intended to neither identify key or critical elements of the disclosure nor delineate the scope thereof. Its sole purpose is to present some concepts in a simplified form as a prelude to the more detailed description that is presented later.

In some embodiments, the disclosed subject matter can comprise a method that can comprise: in response to receiving, from a device, a first buffer status report relating to an uplink data transmission associated with a logical channel group, and based on a buffer status index value contained in the first buffer status report, allocating, by a system comprising at least one processor, an uplink grant that allows the device to communicate an amount of data, as part of the uplink data transmission, to a base station. The method also can comprise determining, by the system, whether a buffer status report value associated with the base station and the logical channel group is a defined value that indicates whether the device is to communicate a second buffer status report with the uplink data transmission. The method further can comprise: based on a result of the determining of whether the buffer status report value is the defined value, determining, by the system, whether to communicate a buffer status report indicator to the device to request the device to communicate the second buffer status report to the base station.

In certain embodiments, the disclosed subject matter can comprise a system that can comprise at least one memory that can store computer executable components, and at least one processor that can execute computer executable components stored in the at least one memory. The computer executable components can comprise a grant allocator, wherein, in response to receiving, from a user equipment, a first buffer status report relating to an uplink data transmission associated with a logical channel group, and based on a buffer status index value contained in the first buffer status report, the grant allocator can allocate an uplink grant that can allow the user equipment to transmit an amount of data, as part of the uplink data transmission, to network equipment. The computer executable components also can comprise a communication manager that can make a determination of whether a buffer status report value associated with the network equipment and the logical channel group is a particular value that can indicate whether the user equipment is to transmit a second buffer status report with the uplink data transmission. Based on a result of the determination of whether the buffer status report value is the defined value, the communication manager can determine whether to transmit a buffer status report indicator to the user equipment to request or instruct the user equipment to transmit the second buffer status report to the network equipment.

In still other embodiments, the disclosed subject matter can comprise a non-transitory machine-readable medium, comprising executable instructions that, when executed by at least one processor, can facilitate performance of operations. The operations can comprise receiving a message from a base station, wherein the message can comprise an uplink grant and a buffer status report indicator that can be associated with a logical channel group, wherein the uplink grant can allow a device to communicate an amount of data associated with the logical channel group to the base station, and wherein the buffer status report indicator can indicate whether the device is to communicate a buffer status report associated with the logical channel group to the base station. The operations also can comprise determining whether the device is to communicate the buffer status report to the base station based on the buffer status report indicator.

The following description and the annexed drawings set forth in detail certain illustrative aspects of the subject disclosure. These aspects are indicative, however, of but a few of the various ways in which the principles of various disclosed aspects can be employed and the disclosure is intended to include all such aspects and their equivalents. Other advantages and features will become apparent from the following detailed description when considered in conjunction with the drawings.

### BRIEF DESCRIPTION OF THE DRAWINGS

FIG. 1 illustrates a block diagram of a non-limiting example system that can desirably manage and perform, or facilitate performance of, instructing, requesting, or notifying devices to communicate buffer status reports (BSRs), and communication of BSRs by the devices, in accordance with various aspects and embodiments of the disclosed subject matter, in accordance with various aspects and embodiments of the disclosed subject matter.

FIG. 2 depicts a block diagram of a non-limiting example communication manager component that desirably can manage and perform, or facilitate performance of, instructing, requesting, or notifying devices to communicate BSRs to a base station, in accordance with various aspects and embodiments of the disclosed subject matter.

FIG. 3 depicts a diagram of an example device communication manager component that desirably can manage and perform communication of BSRs to a base station, in accordance with various aspects and embodiments of the disclosed subject matter.

FIG. 4 illustrates a block diagram of a non-limiting example process flow that can desirably manage and perform, or facilitate performance of, instructing, requesting, or notifying a device to communicate BSRs, and communication of BSRs by the device, in accordance with various aspects and embodiments of the disclosed subject matter.

FIG. 5 depicts a diagram of a non-limiting example enhanced uplink downlink control information (DCI) format that can desirably facilitate communication of BSR indicators to devices using uplink DCI to facilitate indicating whether the devices are to communicate dynamic BSRs to a base station, in accordance with various aspects and embodiments of the disclosed subject matter.

FIG. 6 depicts a block diagram of non-limiting example system that can comprise the communication manager component in a radio access network (RAN) in an open RAN (O-RAN) communication network environment to facilitate desirable management and performance of instructing, requesting, or notifying device to communicate BSRs to the RAN, in accordance with various aspects and embodiments of the disclosed subject matter.

FIG. 7 depicts a diagram of a non-limiting example base station that can desirably facilitate connections and communication of information associated with devices, in accordance with various aspects and embodiments of the disclosed subject matter.

FIG. 8 illustrates a diagram of a non-limiting example device that can be operable to engage in a system architecture that facilitates wireless communications according to one or more embodiments described herein, in accordance with various aspects and embodiments of the disclosed subject matter.

FIG. 9 illustrates a flow chart of an example method that can desirably manage and perform, or facilitate performance of, instructing, requesting, or notifying a device to communicate BSRs to a base station, in accordance with various aspects and embodiments of the disclosed subject matter.

FIGS. 10-12 depict a flow chart of another example method that can desirably manage and perform, or facilitate performance of, instructing, requesting, or notifying a device to communicate BSRs to a base station, in accordance with various aspects and embodiments of the disclosed subject matter.

FIG. 13 depicts a flow chart of another example method that can desirably manage and perform, or facilitate performance of, communication of BSRs by a device to a base station, in accordance with various aspects and embodiments of the disclosed subject matter.

FIG. 14 illustrates an example block diagram of an example computing environment in which the various embodiments of the embodiments described herein can be implemented.

FIG. 15 depicts a diagram of an example process flow that can involve buffer status reporting associated with a device using existing techniques and protocols.

FIG. 16 illustrates a diagram of an example process flow that can involve buffer status reporting associated with a device using certain existing techniques and protocols.

### DETAILED DESCRIPTION

Various aspects of the disclosed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

This disclosure relates generally to systems, mechanisms, methods, and techniques that can enhance, and dynamically perform and manage, buffer status reporting associated with devices (e.g., user equipment (UE) or communication device) associated with (e.g., communicatively connected to) a radio access network (RAN). Buffer status reporting (also referred to herein as BSR, wherein BSR also can refer to buffer status report) can be a medium access control (MAC) layer procedure that can be utilized by a device to provide information regarding the amount of data (e.g., protocol data units (PDUs) or other data) available for transmission in the uplink buffers to the serving base station of the RAN. Using the reported buffer status, the MAC scheduler of the base station can perform uplink resource allocation by allocating only uplink resources (e.g., via an uplink grant) when the device has some data to transmit to the base station, or allocate only certain desired (e.g., wanted or required) resources as indicated by the reported buffer status.

The types of BSR that can be triggered or utilized can include regular BSR, periodic BSR, and padding BSR. Regular BSR can be triggered or utilized, for example, when new uplink data associated with the device becomes available for a logical channel of a logical channel group (LCG) associated with the device, where either no data is available for that LCG or the data (e.g., available uplink data) belongs to another logical channel that has a higher priority. As another example, regular BSR also can be triggered or utilized when a retransmit (retx) BSR timer expires, and the device has data available for transmission for the LCG. Under existing techniques and protocols, when the regular BSR trigger is active and the device does not have an uplink grant, the device has to send a scheduling request to the base station to request uplink resource allocation.

With regard to periodic BSR, the base station can configure a periodic BSR timer that can allow the device to periodically report the buffer status of the device. When the periodic BSR timer expires, the device can report a buffer status report in the next uplink grant provided to the device by the base station.

With regard to padding BSR, when the allocated uplink resources are greater than or equal to the available uplink data of the device, the device can include a padding bit that can fill any unused resource. In a case when the padding bit is greater than the BSR MAC control element (MAC-CE) plus a sub header, the device can include the buffer status report in the communication to the base station.

It is significant to note that, under existing techniques and protocols relating to buffer status reporting, when the device does not have uplink resources allocated and there is uplink data available at the device to be communicated to the base station, only the regular BSR trigger can lead to the device requesting uplink allocation using the scheduling request procedure.

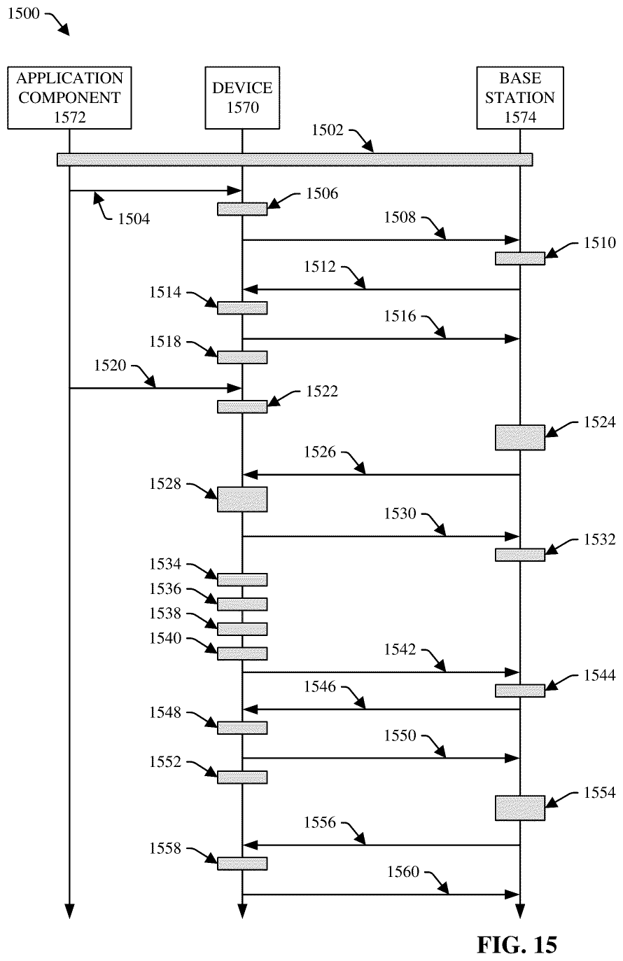

With the existing techniques and protocols for buffer status reporting, it potentially can be the case that, although the device has uplink data available for transmission to the base station, the MAC scheduler of the base station may stop uplink scheduling for the device, if the device has no uplink data (e.g., from the perspective of the base station). Referring to FIG. 15, FIG. 15 depicts a diagram of an example process flow 1500 that can involve buffer status reporting associated with a device using existing techniques and protocols. A device 1570, employing an application 1572, can be associated with (e.g., communicatively connected to) a base station 1574 (e.g., a distributed unit (DU) of the base station) of a RAN. The device 1570 can be connected (e.g., radio resource control (RRC) connected) to the base station 1574 (e.g., gNodeB (gNB)) with, for example, one data radio bearer (DRB) that can belong to an LCG equal to 1 (e.g., LCG=1), as indicated at reference numeral 1502.

As indicated at reference numeral 1504 of the example process flow 1500, the application 1572 employed by the device 1570 can have five uplink PDUs (e.g., PDU1, PDU2, PDU3, PDU4, and PDU5), each comprising, for example, 1000 bytes, communicated to the buffer component of the device 1570, and those five PDUs can be in the buffer component and available for transmission to the base station 1574. As indicated at reference numeral 1506 of the example process flow 1500, the uplink data (e.g., the five PDUs) can arrive for LCG-1 associated with the device 1570 (e.g., the LCG-1 was empty and new uplink data has arrived at the LCG-1), the buffer status report for LCG-1 (e.g., as generated by the device 1570) can be 5000 bytes (e.g., ue_bsr_lcg1=5000 bytes), for the five PDUs, a regular BSR trigger can become active (e.g., activated by the device 1570), as the LCG-1 BSR can change from zero to non-zero, and also at this point, the device 1570 does not have uplink resource allocation from the base station 1574, and the device 1570 can trigger a scheduling request and communicate the scheduling request to obtain uplink resource allocation from the base station 1574 as the regular buffer status reporting associated with the device 1570 is pending.

As indicated at reference numeral 1508 of the example process flow 1500, with the triggering of the scheduling request, the device 1570 can communicate the scheduling request to the base station 1574. As indicated at reference numeral 1510, in response to receiving the scheduling request from the device 1570, the base station 1574 (e.g., the DU (e.g., gNB-DU) of the base station (e.g., gNB)) can allocate an uplink grant to allow the device 1570 to communicate at least a buffer status report. For instance, upon reception of the scheduling request from the device 1570, the MAC scheduler of the DU of the base station 1574 can allocate an uplink grant and uplink downlink control information (DCI) to facilitate obtaining the buffer status report from the device 1570. Accordingly, as indicated at reference numeral 1512, the base station 1574 can communicate the uplink DCI to the device 1570, wherein the uplink DCI can comprise an uplink grant and associated uplink resources that can allow the device 1570 to communicate the buffer status report to the base station 1574.

As indicated at reference numeral 1514 of the example process flow 1500, the device 1570 can generate a buffer status report for LCG=1, wherein, in the buffer status report, LCG=1 and the buffer status can be set to 20, which can correspond to 5446 bytes (e.g., in the device buffer component and available for transmission to the base station 1574), in accordance with existing protocol (e.g., the buffer status of 20 can be indexed, or can correspond, to 5446 bytes, as defined or mapped in a table associated with the existing protocol). As indicated at reference numeral 1516, the device 1570 can communicate the uplink MAC PDU, comprising the BSR, to the base station 1574. As indicated at reference numeral 1518, in response to the device 1570 communicating the BSR to the base station 1574 in accordance with periodic BSR reporting, the device 1570 can restart (e.g., reset) the periodic BSR timer and can restart the retx BSR timer.

As indicated at reference numeral 1520 of the example process flow 1500, subsequent to the sending of the BSR to the base station 1574 and restarting the periodic BSR timer and the retx BSR timer, the application 1572 employed by the device 1570 can have another four uplink PDUs (e.g., PDU6, PDU7, PDU8, and PDU9), each comprising, for example, 1000 bytes, communicated to the buffer component of the device 1570, and those additional four PDUs can be in the buffer component and available for transmission to the base station 1574. Accordingly, as indicated at reference numeral 1522, the additional uplink data (e.g., four uplink PDUs) can arrive for LCG-1, and the buffer status for LCG-1 can now be 9000 bytes (e.g., ue_bsr_lcg1=9000 bytes).

As indicated at reference numeral 1524 of the example process flow 1500, in response to receiving the uplink MAC PDU, comprising the BSR, from the device 1570, the base station 1574 (e.g., the DU of the base station) can update the BSR for LCG-1 for the base station 1574 and associated with the device 1570 to 5446 bytes (e.g., gnb_bsr_lcg1=5446 bytes) based on the buffer status reported in the BSR, the base station 1570 can allocate an uplink grant to allow the device 1570 to send uplink data of, for example, less than or equal to 5446 bytes, corresponding to the BSR, the uplink grant can allow the device 1570 to send, for example, 6000 bytes, and the base station 1574 can update the BSR for LCG-1 to 0 bytes (e.g., gnb_bsr_lcg1=0 bytes). As indicated at reference numeral 1526, the base station 1574 can communicate uplink DCI, comprising the uplink grant (e.g., to allow the device 1570 to send up to 6000 bytes) and associated resources, to the device 1570.

As indicated at reference numeral 1528 of the example process flow 1500, in response to receiving the uplink DCI, including the uplink grant and associated resources, the device 1570 can prepare a message (e.g., uplink MAC PDU) to send 6000 bytes (e.g., PDU1, PDU2, PDU3, PDU4, PDU5, and PDU6) to the base station 1574, since the uplink grant permits the device 1570 to send up to 6000 bytes. The device 1570 may not include the BSR in the message, since none of the BSR triggers are active (e.g., the periodic BSR timer and the retx BSR timer have not yet expired). It is noted that, in this example scenario, for ease of understanding, the MAC header for the PDU has been excluded from the calculation of the amount of uplink data being sent. As indicated at reference numeral 1530, the device 1570 can communicate the message (e.g., the uplink MAC PDU), comprising PDU1, PDU2, PDU3, PDU4, PDU5, and PDU6, to the base station 1574.

As indicated at reference numeral 1532 of the example process flow 1500, in response to receiving the message, the base station 1574 may not allocate another uplink grant for the device 1570, since there was no BSR in the message, and the BSR for LCG-1 is 0 at the base station 1570.

As indicated at reference numeral 1534 of the example process flow 1500, subsequent to the sending of the UL MAC PDU message to the base station 1574, the periodic BSR timer can expire (e.g., after some time has elapsed) at the device 1570. However, as indicated at reference numeral 1536, under existing techniques and protocols, even though the device 1570 has three uplink PDUs (e.g., PDU7, PDU8, and PDU9) available to send to the base station 1574, at this time, a scheduling request to request uplink allocation from the base station 1574 may not be allowed to be sent for periodic BSR by the device 1570. For instance, since there are three uplink PDUs available at the device 1570 (e.g., in the buffer component) to send to the base station 1574, the periodic BSR trigger can become active. However, even though the device 1570 has three uplink PDUs buffered in the buffer component, at this time, under existing techniques and protocols, the device 1570 may not be allowed to request uplink allocation to send those three uplink PDUs to the base station 1574. This can be due to the fact that only regular BSR can trigger sending the scheduling request to the base station 1574.

Subsequently, as indicated at reference numeral 1538, the retx BSR timer can expire at the device 1570. Since there are three uplink PDUs available at the device 1570 to send to the base station 1574, and the retx BSR timer has expired, the regular BSR trigger can become active, and the device 1570 now can be permitted to communicate a scheduling request for uplink allocation, under existing techniques and protocols. As indicated at reference numeral 1540, in response to the retx BSR timer expiring and the regular BSR trigger becoming active, a regular BSR can be sent, and the device 1570 can generate a scheduling request to request uplink allocation from the base station 1574, so that the device 1570 can send the BSR (e.g., regular BSR) to the base station 1574. As indicated at reference numeral 1542, the device 1570 can communicate the scheduling request requesting uplink allocation to the base station 1574.

As indicated at reference numeral 1544 of the example process flow 1500, in response to receiving the scheduling request from the device 1570, the base station 1574 (e.g., the DU MAC scheduler of the base station) can allocate an uplink DCI and uplink grant to allow the device 1570 to at least communicate a BSR to the base station 1574. As indicated at reference numeral 1546, the base station 1574 can communicate the uplink DCI, comprising the uplink grant and associated resources, to the device 1570.

As indicated at reference numeral 1548 of the example process flow 1500, in response to receiving the uplink DCI from the base station 1574, the device 1570 can generate a BSR for LCG=1, wherein, in the BSR, the buffer status can be set to 19, which can correspond to 3909 bytes, under existing techniques and protocols, since the device 1570 has 3000 bytes (e.g., PDU7, PDU8, and PDU9) available to send to the base station 1574. As indicated at reference numeral 1550, the device 1570 can communicate the uplink MAC PDU, comprising the BSR, to the base station 1574, wherein the BSR can comprise LCG=1 and the buffer status set to 19. As indicated at reference numeral 1552, in response to the device 1570 communicating the BSR to the base station 1574 in accordance with periodic BSR reporting, the device 1570 can restart the periodic BSR timer and can restart the retx BSR timer.

As indicated at reference numeral 1554 of the example process flow 1500, in response to receiving the uplink MAC PDU, comprising the BSR, from the device 1570, the base station 1574 (e.g., the DU MAC scheduler of the base station) can update the BSR for LCG-1 for the base station 1574 and associated with the device 1570 to 3909 bytes (e.g., gnb_bsr_lcg1=3909 bytes) based on the buffer status (e.g., buffer status index=19) reported in the BSR, the base station 1570 (e.g., the DU MAC scheduler of the base station) can allocate an uplink grant and associated resources to allow the device 1570 to send uplink data of, for example, less than or equal to 3909 bytes, corresponding to the BSR, the uplink grant can allow the device 1570 to send, for example, 4000 bytes, and the base station 1574 can update the BSR for LCG-1 to 0 bytes (e.g., gnb_bsr_lcg1=0 bytes). As indicated at reference numeral 1556, the base station 1574 can communicate uplink DCI, comprising the uplink grant (e.g., to allow the device 1570 to send up to 4000 bytes) and associated resources, to the device 1570.

As indicated at reference numeral 1558 of the example process flow 1500, in response to receiving the uplink DCI, comprising the uplink grant and associated resources, the device 1570 can prepare a message (e.g., uplink MAC PDU) to send 4000 bytes (e.g., PDU7, PDU8, and PDU9; and padding BSR) to the base station 1574, since the uplink grant permits the device 1570 to send up to 4000 bytes. It is noted that, since the uplink grant is for 4000 bytes, which can be greater than the available uplink data of 3000 bytes, the device 1570 also can include the padding BSR that can comprise a buffer status (BS) of 0 for LCG-1 (e.g., padding BSR(LCG-1, BS=0)) and padding bits that can take up any remaining space (e.g., unused resources) in the uplink communication of 4000 bytes. As indicated at reference numeral 1560, the device 1570 can communicate the message (e.g., the uplink MAC PDU), comprising PDU7, PDU8, PDU9, and the padding BSR, to the base station 1574.

The existing techniques and protocols can be deficient and problematic for a number of reasons. For instance, as indicated above, after the operation of 1530 (e.g., after the device 1570 sends the uplink MAC PDU message comprising PDU1 through PDU6), under existing techniques and protocols, the base station 1574 can discontinue uplink scheduling for the device 1570, as the base station 1574 make a determination (e.g., an incorrect and uninformed determination) that the device 1570 does not have any other uplink data to send to the base station 1574, based on no BSR being included in the uplink MAC PDU message received from the device 1570 (e.g., as, under existing techniques and protocols, none of the BSR triggers is active, and the device 1570 cannot send a BSR to the base station 1574), even though the device 1570 actually does have three more PDUs (e.g., PDU7, PDU8, and PDU9) to send to the base station 1574. This has led to the transmission of uplink data by the device 1570 to the base station 1574 to undesirably stall and be delayed. Such undesirable stall and delay in the transmission of the other uplink data (e.g., PDU7, PDU8, and PDU9) by the device 1570 to the base station 1574 can be resolved only after the retx BSR timer expires at the device 1570 (e.g., as indicated at reference numeral 1538). The duration of this undesirable amount of stalling of transmission of uplink data by the device 1570 can depend on the configuration of the retx BSR timer (e.g., the amount of time set for the retx BSR timer).

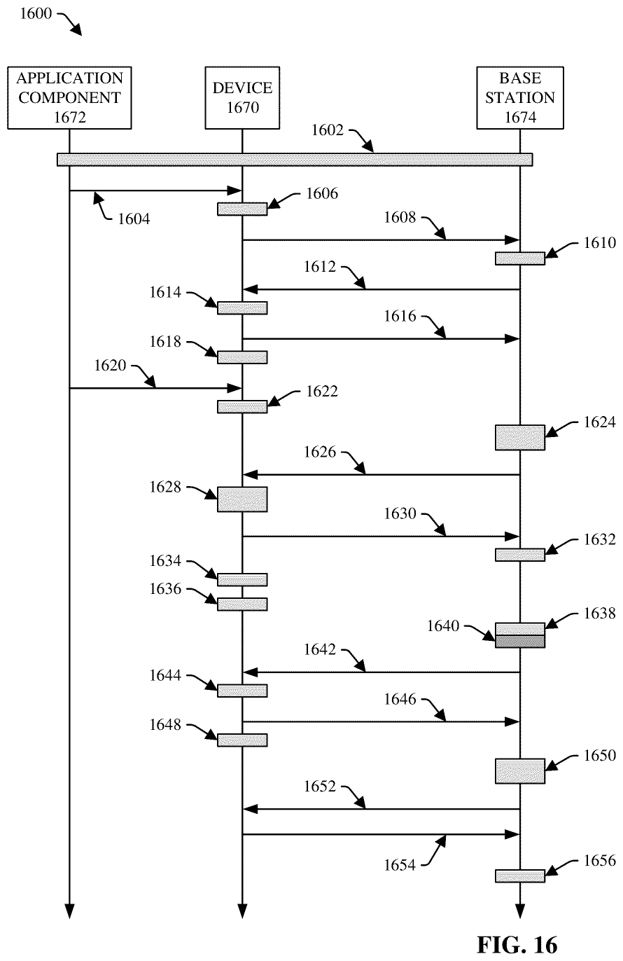

Certain existing techniques can involve the base station (e.g., DU MAC scheduler of the base station) providing an additional uplink grant after BSR at the base station becomes 0, which can allow the device to send an updated BSR using the additional uplink grant. In that regard, referring to FIG. 16, FIG. 16 illustrates a diagram of an example process flow 1600 (e.g., signal flow) that can involve buffer status reporting associated with a device using certain existing techniques and protocols. A device 1670, employing an application 1672, can be associated with (e.g., communicatively connected to) a base station 1674 (e.g., a DU of the base station) of a RAN. The device 1670 can be connected (e.g., RRC connected) to the base station 1674 with, for example, one DRB that can belong to an LCG equal to 1 (e.g., LCG=1), as indicated at reference numeral 1602. The respective operations, messages, and/or signals indicated at reference numerals 1602, 1604, 1606, 1608, 1610, 1612, 1614, 1616, 1618, 1620, 1622, 1624, 1626, 1628, and 1630 of the example process flow 1600 of FIG. 16 can correspond to (e.g., can be the same or substantially the same as) the respective operations, messages, and/or signals indicated at reference numerals 1502, 1504, 1506, 1508, 1510, 1512, 1514, 1516, 1518, 1520, 1522, 1524, 1526, 1528, and 1530 of the example process flow 1500 of FIG. 15.

As indicated at reference numeral 1632 of the example process flow 1600, in response to receiving the message, since no BSR was included in the message (e.g., the UL MAC PDU message comprising PDU1, PDU2, PDU3, PDU4, PDU5, and PDU6), and accordingly, BSR for LCG-1 can be 0 at the base station 1600, the base station 1674 can initiate (e.g., start) an uplink grant timer that can have a time period equal to the period BSR timer (e.g., an amount of time of the period BSR timer) associated with the device 1600 plus a delta amount of time. At this time (e.g., before expiration of the uplink grant timer), the base station 1674 may not allocate another uplink grant for the device 1670, since there was no BSR in the message, and the BSR for LCG-1 is 0 at the base station 1670.

As indicated at reference numeral 1634 of the example process flow 1600, subsequent to the sending of the UL MAC PDU message to the base station 1674, the periodic BSR timer can expire (e.g., after some time has elapsed) at the device 1670. However, as indicated at reference numeral 1636, under the certain existing techniques and protocols, even though the device 1670 has three uplink PDUs (e.g., PDU7, PDU8, and PDU9) available to send to the base station 1674, at this time, a scheduling request to request uplink allocation from the base station 1674 may not be allowed to be sent for periodic BSR by the device 1670. For instance, since there are three uplink PDUs available at the device 1670 (e.g., in the buffer component) to send to the base station 1674, the periodic BSR trigger can become active. However, even though the device 1670 has three uplink PDUs buffered in the buffer component, at this time, under the certain existing techniques and protocols, the device 1670 may not be allowed to request uplink allocation to send those three uplink PDUs to the base station 1674. This can be due to the fact that only regular BSR can trigger sending of the scheduling request to the base station 1674.

As indicated at reference numeral 1638 of the example process flow 1600, the uplink grant timer can expire. As indicated at reference numeral 1640, in response to the uplink grant timer expiring, the base station 1674 (e.g., the DU MAC scheduler of the base station) can allocate an uplink grant and associated resources to allow the device 1670 to at least send a BSR to the base station 1674. As indicated at reference numeral 1642, the base station 1674 can communicate the uplink DCI, comprising the uplink grant and associated resources, to the device 1670.

As indicated at reference numeral 1644 of the example process flow 1600, in response to receiving the uplink DCI from the base station 1674, the device 1670 can generate a BSR for LCG=1, wherein, in the BSR, the buffer status can be set to 19, which can correspond to 3909 bytes, under the certain existing techniques and protocols, since the device 1670 has 3000 bytes (e.g., PDU7, PDU8, and PDU9) available to send to the base station 1674. As indicated at reference numeral 1646, the device 1670 can communicate the uplink MAC PDU, comprising the BSR, to the base station 1674, wherein the BSR can comprise information indicating that LCG=1 and the buffer status is set to 19. As indicated at reference numeral 1648, in response to the device 1670 communicating the BSR to the base station 1674 in accordance with periodic BSR reporting, the device 1670 can restart the periodic BSR timer and can restart the retx BSR timer.

As indicated at reference numeral 1650 of the example process flow 1600, in response to receiving the uplink MAC PDU, comprising the BSR, from the device 1670, the base station 1674 (e.g., the DU MAC scheduler of the base station) can update the BSR for LCG-1 for the base station 1674 and associated with the device 1670 to 3909 bytes (e.g., gnb_bsr_lcg1=3909 bytes) based on the buffer status (e.g., buffer status index=19) reported in the BSR, the base station 1670 (e.g., the DU MAC scheduler of the base station) can allocate an uplink grant and associated resources to allow the device 1670 to send uplink data of, for example, less than or equal to 3909 bytes, corresponding to the BSR, the uplink grant can allow the device 1670 to send, for example, 4000 bytes, the base station 1674 can update the BSR for LCG-1 to 0 bytes (e.g., gnb_bsr_lcg1=0 bytes), and the base station 1674 can start an uplink grant timer (e.g., a next or new uplink grant timer). As indicated at reference numeral 1652, the base station 1674 can communicate uplink DCI, comprising the uplink grant (e.g., to allow the device 1670 to send up to 4000 bytes) and associated resources, to the device 1670.

As indicated at reference numeral 1654 of the example process flow 1600, in response to receiving the uplink DCI, comprising the uplink grant and associated resources, the device 1670 can prepare and communicate a message (e.g., uplink MAC PDU) to send 4000 bytes (e.g., PDU7, PDU8, and PDU9; and padding BSR) to the base station 1674, since the uplink grant permits the device 1670 to send up to 4000 bytes. It is noted that, since the uplink grant is for 4000 bytes, which can be greater than the available uplink data of 3000 bytes, the device 1670 also can include the padding BSR that can comprise a buffer status of 0 for LCG-1 (e.g., padding BSR(LCG-1, BS=0)) and padding bits that can take up any remaining space (e.g., unused resources) in the uplink communication of 4000 bytes.

As indicated at reference numeral 1656 of the example process flow 1600, the base station 1674 can update the BSR for LCG-1 to 0 bytes (e.g., gnb_bsr_lcg1=0 bytes), and the base station 1674 can discontinue (e.g., stop or cease) the uplink grant timer, since the BSR received from the device 1670 indicates that the buffer status is 0 for LCG-1 associated with the device 1670.

The certain existing techniques and protocols can be deficient and problematic for a number of reasons. For instance, as indicated above, the base station (e.g., DU MAC scheduler of the base station) has to allocate an additional uplink grant and uplink DCI to set or allow the updated BSR for the device. This can result in undesirable waste of uplink resources. Another problem with these certain existing techniques and protocols can be that the base station has to allocate the additional uplink grant and uplink DCI only after the periodic BSR timer has expired on the device. Consequently, the base station has to wait for a period of time that is greater than the periodic BSR timer before allocating the additional uplink grant and uplink DCI to set or allow the updated BSR. This can result in an undesirable delay in the uplink data transfer of the other uplink data (e.g., PDU7, PDU8, and PDU9) by the device to the base station, wherein the amount of such data transfer delay can depend on the duration of the periodic BSR timer.

Still other existing techniques can be configuring a relatively smaller value for the retx BSR timer (e.g., a shorter retx BSR timer). However, such other existing techniques also can be deficient and problematic for a number of reasons. Configuring a shorter retx BSR timer can undesirably result in more frequent sending of scheduling requests by the device. Since scheduling requests can be a higher priority transmission, this can undesirably impact uplink data transmission scheduling for other devices associated with the base station.

It can be desirable to address and overcome the aforementioned deficiencies and other deficiencies of the existing systems and techniques. In that regard, the disclosed subject matter can provide enhanced techniques and protocols that can desirably (e.g., suitably, beneficially, advantageously, usefully, enhancedly, or optimally) address and overcome the aforementioned deficiencies and other deficiencies of the existing systems and techniques.

To that end, techniques that can desirably (e.g., automatically, dynamically, suitably, reliably, efficiently, enhancedly, and/or optimally) manage and perform, or facilitate performance of, instructing, requesting, or notifying devices to communicate BSRs (e.g., dynamic or on-demand BSRs), and communication of BSRs by the devices to base stations, are presented. A system can comprise a communication network that can comprise a core network and one or more RANs. The core network that can be associated with (e.g., communicatively connected to) the one or more RANs. The core network can comprise various network functions, components, and equipment that can facilitate communication (e.g., wireless communication) of information (e.g., voice traffic, data traffic) to or from devices (e.g., communication devices) associated with (e.g., wirelessly connected to) the core network or another network of the communication network. A RAN can comprise one or more base stations that can facilitate communication (e.g., wireless communication) of data between devices associated with the communication network (e.g., communicatively connected to a base station of the core network, or otherwise connected to the communication network).

In accordance with various embodiments, a base station of the RAN can comprise or can be associated with a communication manager component (e.g., of or associated with a DU of the base station) that can desirably (e.g., automatically, dynamically, suitably, reliably, efficiently, enhancedly, and/or optimally) manage (e.g., control) and perform, or facilitate performance of, instructing, requesting, or notifying devices to communicate BSRs (e.g., dynamic or on-demand BSRs) to the base station, and communication of BSRs by devices, associated with the base station, to the base station, in accordance with an enhanced BSR protocol and defined communication management criteria. A device can have a first amount of data associated with an LCG available (e.g., in its buffer component) for communication to the base station. The base station can receive a first BSR (e.g., a regular BSR or other type of BSR), comprising a first buffer status index value, from the device, wherein the first buffer status index value can indicate a second amount of data (e.g., second amount of data greater than or equal to the first amount of data) associated with the LCG can be available at the device for communication to the base station. In some instances, after the device has communicated the first BSR associated with the LCG to the base station, the device may have an additional amount of data (e.g., generated or received by an application associated with the device) associated with the LCG that can be available (e.g., in its buffer component) for communication to the base station.

In response to receiving the first BSR, the base station, employing the communication manager component, can analyze the first BSR, including the first buffer status index value. In certain embodiments, based at least in part on the results of analyzing the first buffer status index value, the communication manager component can determine that the device has the second amount of data (e.g., up to the second amount of data) associated with the LCG available for communication to the base station, can update the base-station BSR associated with the LCG to the second amount of data (e.g., a value that can be or can be representative of the second amount of data, and can allocate an uplink grant to allow the device to communicate a third amount of data (e.g., up to the third amount of data) associated with the LCG to the base station, wherein the third amount of data can be greater than or equal to the second amount of data (e.g., and can be less than the total of the first amount of data and the additional amount of data available at the device for communication to the base station). In some embodiments, in response to allocating the uplink grant to allow the device to communicate the third amount of data associated with the LCG to the base station, the communication manager component can update the base-station BSR to an updated BSR value, such as, for example, 0 bytes (e.g., 0 bytes or a value that can be representative of 0 bytes).

In certain embodiments, the communication manager component can determine whether the updated BSR value associated with base-station BSR associated with the LCG is a defined value (e.g., 0 bytes or other desired defined value) that can indicate a second BSR associated with the LCG is to be sent by the device to the base station. In some embodiments, based at least in part on determining that the updated BSR value is the defined value and/or based at least in part on other information (such as described herein), the communication manager component can determine a BSR indicator, which can have a send-report BSR indicator value, can be communicated to the device to request the device to communicate a second BSR (e.g., a dynamic or on-demand BSR) to the base station, in accordance with the enhanced BSR protocol and the defined communication management criteria. The base station can communicate a message (e.g., uplink DCI message), comprising the uplink grant and the BSR indicator, to the device. In some embodiments, if, instead, based at least in part on the results of analyzing the updated base-station BSR and/or other information (e.g., such as described herein), the communication manager component determines that the device is not to communicate a BSR (e.g., dynamic or on-demand BSR) to the base station, the communication manager component can have the base station communicate a BSR indicator that can have a no-report BSR indicator value to the device to indicate to or inform the device that the device is not to or does not have to communicate such a BSR to the base station, in accordance with the enhanced BSR protocol and the defined communication management criteria.

In certain embodiments, based at least in part on the results of analyzing the message, comprising the uplink grant and the BSR indicator, the device (e.g., employing a device communication manager component) can determine that the device is to communicate the second BSR (e.g., dynamic or on-demand BSR) associated with the LCG that can indicate the amount of data (e.g., the remaining amount of data, if any) that can be available at the device for communication to the base station (e.g., after up to the third amount of data is communicated by the device to the base station, in accordance with the uplink grant). The device communication manager component can determine a second buffer status index value that can indicate the remaining amount of data (e.g., the additional amount of data (if any), or portion thereof), if any, that can remain available at the device for communication to the base station (e.g., after up to the third amount of data is communicated by the device to the base station, in accordance with the uplink grant), and can generate the second BSR, comprising the second buffer status index value, wherein the second buffer status index value can indicate that a fourth amount of data (e.g., greater than or equal to the remaining amount of data) can remain available at the device for communication to the base station. The device can communicate a message (e.g., uplink MAC PDU message), comprising up to the third amount of data and the second BSR, to the base station, in accordance with the uplink grant, and the base station can receive such message.

In accordance with various embodiments, the base station (e.g., employing the communication manager component) and the device (e.g., employing the device communication manager component) can continue to perform the enhanced BSR process. In some embodiments, if and when the device communicates, to the base station, a BSR (e.g., dynamic or on-demand BSR associated with the LCG), comprising a particular buffer status index value (e.g., a buffer status index value of 0 or representative of 0 bytes of data) that can indicate that the device has no data associated with the LCG remaining available (e.g., in its buffer component, at least at that time) for communication to the base station. If the base station receives such a BSR, comprising the particular buffer status index value, associated with the LCG from the device, the communication manager component can determine that the device has no data associated with the LCG remaining available for communication to the base station, based at least in part on the result of analyzing the particular buffer status index value. In certain embodiments, in response to determining that the device has no data associated with the LCG remaining available for communication to the base station, the communication manager component can determine that uplink allocation associated with the LCG can be discontinued for the device, and can discontinue or facilitate discontinuation of the uplink allocation associated with the LCG for the device (e.g., at least at that time), in accordance with the enhanced techniques, BSR protocol, and defined communication management criteria.

The disclosed subject matter, by employing the communication manager component associated with the base station, the device communication manager component associated with the device, and the enhanced techniques described herein, can desirably (e.g., automatically, dynamically, suitably, reliably, efficiently, enhancedly, and/or optimally) manage and perform, or facilitate performance of, instructing, requesting, or notifying devices to communicate BSRs (e.g., dynamic or on-demand BSRs), and communication of BSRs by the devices. The disclosed subject matter, by employing the communication manager component associated with the base station, the device communication manager component associated with the device, and the enhanced techniques described herein, can reduce utilization of uplink resources and reduce uplink resource wastage, as, for example, the base station (e.g., DU MAC scheduler of the base station), when sending an uplink grant and/or uplink DCI, can instruct or request the device to include a BSR (e.g., a latest BSR) associated with an LCG and the device in an uplink communication by the device to the base station, and accordingly, no additional uplink grant and/or uplink DCI has to be utilized to obtain the BSR (e.g., the latest BSR) associated with the LCG and the device. The disclosed subject matter, by employing the communication manager component associated with the base station, the device communication manager component associated with the device, and the enhanced techniques described herein, can reduce or eliminate an uplink data stall, as, for example, the base station can instruct or request (e.g., automatically or dynamically instruct or request) a BSR (e.g., a latest BSR) from a device, and accordingly, that can be no delay, or at least reduced (e.g., minimal) delay, in uplink scheduling of communication of data for the device, as compared to existing techniques relating to BSRs and uplink scheduling. The disclosed subject matter, by employing the communication manager component associated with the base station, the device communication manager component associated with the device, and the enhanced techniques described herein, can enhance (e.g., improve or optimize) round-trip time (RTT) associated with the device and base station, as, for example, RTT associated with the device and base station can be reduced (e.g., decreased or minimized) due in part to reduction in uplink scheduling delay associated with the device, which can lead to improved uplink performance associated with the device, as compared to existing techniques relating to BSRs and uplink scheduling. The disclosed subject matter, by employing the communication manager component associated with the base station, the device communication manager component associated with the device, and the enhanced techniques described herein, can reduce dependency in the periodic BSR timer associated with the device, as, for example, the device can send a BSR (e.g., a latest BSR) associated with an LCG and device when instructed or requested by the base station, and accordingly, there can be no delay, or reduced (e.g., minimized) instances of delay, in the sending of BSRs by the device to the base station due to the periodic BSR timer, and this can allow the base station (e.g., DU of the base station) to configure the periodic BSR timer more freely, as compared to existing techniques relating to BSRs.

These and other aspects and embodiments of the disclosed subject matter will now be described with respect to the drawings.

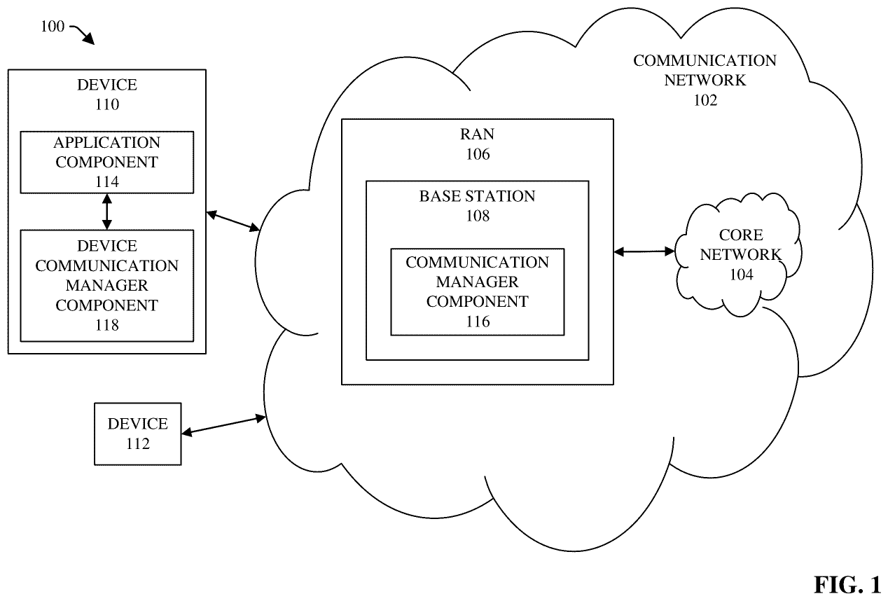

Referring now to the drawings, FIG. 1 illustrates a block diagram of a non-limiting example system 100 that can desirably (e.g., automatically, dynamically, suitably, reliably, efficiently, enhancedly, and/or optimally) manage and perform, or facilitate performance of, instructing, requesting, or notifying devices to communicate BSRs (e.g., dynamic or on-demand BSRs), and communication of BSRs by the devices, in accordance with various aspects and embodiments of the disclosed subject matter. The system 100 can comprise a communication network 102 that can comprise a core network 104 and one or more radio access networks (RANs), such as RAN 106, that can be associated with (e.g., communicatively connected to) the core network 104. Each RAN (e.g., RAN 106) can comprise one or more base stations, such as base station 108, that each can comprise one or more cells (not shown in FIG. 1).

The core network 104, the one or more RANs (e.g., RAN 106), the one or more base stations (e.g., base station 108), and the one or more cells can facilitate (e.g., enable) wireless communication of data (e.g., voice or other audio data, video data, textual data, or other data) between devices (e.g., communication devices or UEs), such as devices associated with the core network 104, via the one or more RANs, one or more base stations, and one or more cells, and other devices associated with the core network 104 or, more generally, the communication network 102 (e.g., a device, such as a server or computer, can be connected to the communication network 102 via a wireline connection or via a network other than the core network 104).

The devices can comprise, for example, devices 110 and/or 112. A device (e.g., 110 or 112) can be, for example, a wireless, mobile, or smart phone, a computer, a laptop computer, a server, an electronic pad or tablet, a virtual assistant (VA) device, electronic eyewear, an electronic watch, or other electronic bodywear, an electronic gaming device, an Internet of Things (IoT) device (e.g., a health monitoring device, a toaster, a coffee maker, blinds, a music player, speakers, a telemetry device, a smart meter, a machine-to-machine (M2M) device, or other type of IoT device), a device of a connected vehicle (e.g., car, airplane, train, rocket, and/or other at least partially automated vehicle (e.g., drone)), a personal digital assistant (PDA), a dongle (e.g., a universal serial bus (USB) or other type of dongle), a communication device, or other type of device. In some embodiments, the non-limiting term UE can be used to describe the device. The device (e.g., 110 or 112) can be associated with (e.g., communicatively connected to) the communication network 102 via a communication connection and channel, which can include a wireless or wireline communication connection and channel.

In accordance with various embodiments, the core network 104 can comprise various network components that can facilitate wireless communication of data. In some embodiments, the RAN 106 can be a 5G or other NR RAN (e.g., gNB or other NR-type or xG RAN, wherein x can be a number greater than 5), and/or the base station(s) can be a 5G or other NR base station (e.g., gNB or other NR-type or xG base station, wherein x can be a number greater than 5). In some embodiments, the RAN 106 can be an open RAN (O-RAN) that can be part of an O-RAN architecture and environment (e.g., the communication network 102 can employ an O-RAN architecture and environment). In certain embodiments, the core network 104 can comprise a user plane function (UPF) (also can be referred to as a UPF node), an application function (AF) (also can be referred to as an AF node), an application server, an access and mobility management function (AMF), and/or other network functions (not shown in FIG. 1 for reasons of brevity and clarity). The UPF can connect to or interface with the one or more RANs (e.g., RAN 106) and the one or more base stations, can be an interconnect point between the core network 104 and a data network (DN), can provide or facilitate providing a protocol data unit (PDU) session anchor point for providing mobility associated with radio access technologies (RATs), can provide or facilitate providing data packet routing or forwarding, and/or can perform or manage other functions.

The AF, which can be a control plane function, can be associated with, and can act as or fulfill all or part of the role of, the application server, and can interact and communicate with other network functions, including control plane functions, of the core network 104. The AF and associated application server can facilitate (e.g., enable) provision of various services (e.g., voice services, messaging services, media streaming services, Internet and intranet services, multimedia conferencing and collaboration services, or other services) and applications to devices associated with the core network 104. In some embodiments, some of the services can be low latency services and/or network edge services. The AF can comprise one or more AFs that respectively can be owned or managed by the network operator of the core network 104 or by third parties (e.g., trusted third parties). In some embodiments, the UPF can be associated with, and can interact and communicate with, the AF and/or other network functions (e.g., other control plane functions) via a service-based interface (SBI).

The AMF node can be a control plane function that can manage registration and deregistration of devices (e.g., devices 110 and/or 112) with the core network 104, manage connections of devices with the core network 104, manage mobility associated with devices (e.g., maintain knowledge of locations of devices, update locations of devices), and/or manage or perform other functions. In accordance with various other embodiments, the RAN(s) (e.g., RAN 106) and/or the base station(s) can comprise both 4^{th} generation (4G) long term evolution (LTE) technology and functions, and 5G or other NR-type or xG technology and functions.

The communication network 102, more generally, or the core network 104 can comprise various other network equipment (e.g., routers, gateways, transceivers, switches, access points, network functions, processor components, data stores, or other devices or network nodes) that facilitate (e.g., enable) communication of information between respective items of network equipment of the communication network 102, and/or communication of information between the one or more devices (e.g., devices 110 and/or 112) and the communication network 102. The communication network 102, including the core network 104, can provide or facilitate wireless or wireline communication connections and channels between the one or more devices (e.g., devices 110 and/or 112), and/or respectively associated services or applications, and the communication network 102. For reasons of brevity or clarity, some of the various network equipment, components, functions, or devices of the communication network may not be explicitly shown or described herein.

At various times, the respective devices (e.g., devices 110 and/or 112) can utilize respective services or applications. For instance, the device 110 can comprise or can be associated with (e.g., communicatively connected to) an application component 114 that can enable the device 110 to access and utilize one or more applications and/or one or more services. The services or applications can comprise or relate to, for example, voice service (e.g., conversational voice services or other voice services), video streaming service, conversational video service, buffered video service, audio streaming service, other type of streaming service, text or messaging service, data service, control message service (e.g., control message service relating to control of communication network functions and operations), signaling service, real time gaming service, interactive gaming service, transmission control protocol (TCP) service, control message service relating to automated or semi-automated vehicles or motorized devices, law enforcement-related service, medical-related service, emergency-related service, military-related service, background traffic service, or other desired types of service. In some embodiments, a service can be an extended reality (XR) service or other type of service that can involve or relate to communication of data bursts comprising PDU sets.

To facilitate communication of data between a device and a base station, the device can communicate a buffer status report that can indicate an amount of data the device can have available (e.g., in its buffer component) for communication to the base station. However, existing techniques and protocols relating to buffer status reporting can be deficient and problematic for a variety of reasons, such as described herein.

The disclosed subject matter can overcome these deficiencies and other problems of existing techniques. To that end, in accordance with various embodiments, the system 100 (e.g., the RAN 106 or base station 108) can comprise a communication manager component 116 that desirably (e.g., automatically, dynamically, suitably, reliably, efficiently, enhancedly, and/or optimally) can manage and perform, or facilitate performance of, communication of BSRs (e.g., dynamic or on-demand BSRs), associated with devices. Also, in accordance with various embodiments, the system 100 (e.g., the device 110 or device 112) can comprise a device communication manager component 118 that desirably (e.g., automatically, dynamically, suitably, reliably, efficiently, enhancedly, and/or optimally) can manage and perform communication of BSRs (e.g., dynamic or on-demand BSRs) to the base station 108 associated with the device.

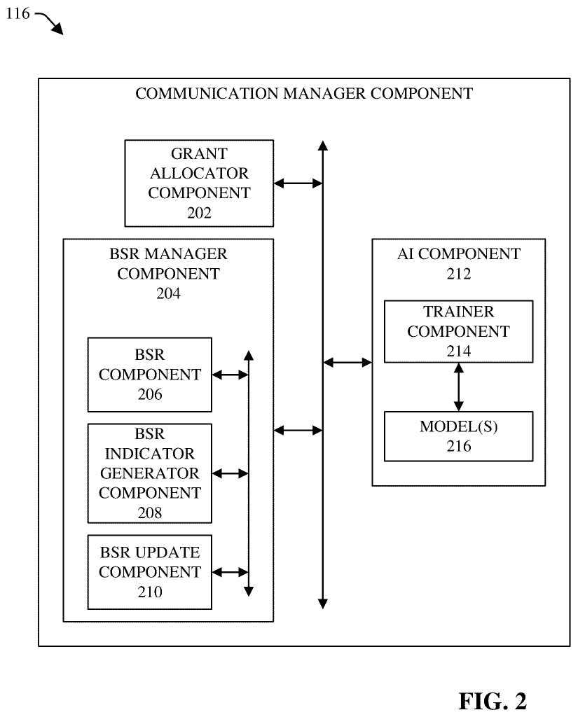

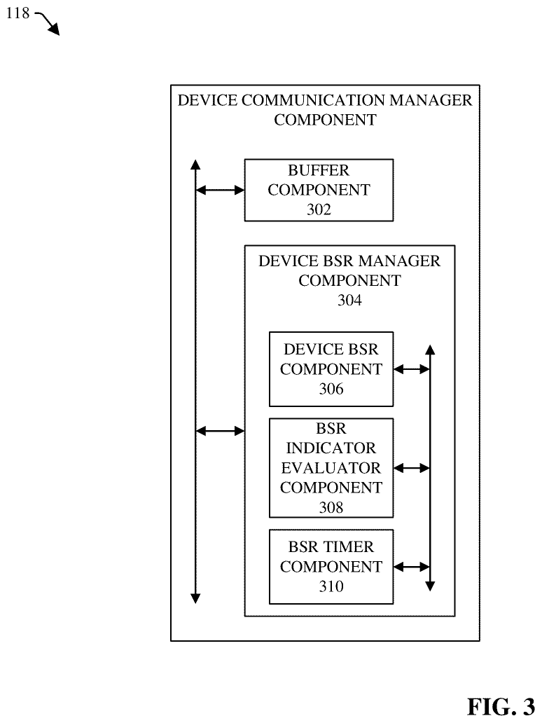

Referring to FIGS. 2 and 3 (along with FIG. 1), FIG. 2 depicts a block diagram of an example communication manager component 116 that desirably can manage and perform, or facilitate performance of, instructing, requesting, or notifying devices (e.g., devices 110 and/or 112) to communicate BSRs (e.g., dynamic or on-demand BSRs) to the base station 108, and FIG. 3 depicts a block diagram of an example device communication manager component 118 that desirably can manage and perform communication of BSRs to a base station (e.g., base station 108 or other base station), in accordance with various aspects and embodiments of the disclosed subject matter. In accordance with various embodiments, the communication manager component 116 can comprise a grant allocator component 202 and a BSR manager component 204, which can comprise a BSR component 206, a BSR indicator generator component 208, and a BSR update component 210. In accordance with various embodiments, the communication manager component 116 can comprise or can be associated with an artificial intelligence (AI) component 212, which can comprise a trainer component 214 and one or more models 216 (e.g., AI-based models). In accordance with various embodiments, the device communication manager component 118 can comprise a buffer component 302 and a device BSR manager component 304, which can comprise a device BSR component 306, a BSR indicator evaluator component 308, and a BSR timer component 310.

In some embodiments, the communication manager component 116 (e.g., employing the BSR manager component 204) can determine whether a device (e.g., device 110 or device 112) is to send a BSR (e.g., a dynamic or on-demand BSR) associated with a particular LCG associated with the device to the base station 108 (e.g., DU of the base station 108) based at least in part on a result of a determination of whether a current buffer status value associated with the base-station BSR for the particular LCG is at a defined value (e.g., 0 bytes or other desired defined value), which can indicate that it can be desired (e.g., wanted, useful, or optimal) for the device 110 to communicate the BSR to the base station 108, in accordance with defined communication management criteria and enhanced BSR protocol. For instance, after receiving a previous BSR (e.g., a regular BSR or other previous BSR) associated with the particular LCG from the device, the BSR manager component 204 can determine whether the device is to send a BSR (e.g., a dynamic or on-demand BSR) associated with the particular LCG to the base station 108 based at least in part on the result of the determination of whether the current buffer status value associated with the base-station BSR for the particular LCG (e.g., a current updated buffer status value after an uplink allocation) is at the defined value, wherein such current buffer status value associated with the base-station BSR for the particular LCG can be determined (e.g., by the communication manager component 116) during processing of the previous BSR, such as described herein. For example, in connection with processing the previous BSR associated with the particular LCG that was received from the device, if the BSR manager component 204 determines that the current buffer status value associated with the base-station BSR for the particular LCG (e.g., a current updated buffer status value after an uplink allocation) is at the defined value, the BSR manager component 204 can determine that the device is to send a BSR (e.g., a dynamic or on-demand BSR) associated with the particular LCG to the base station 108, such as described herein.

In certain embodiments, the BSR manager component 204 can determine whether the device is to send a BSR (e.g., a dynamic or on-demand BSR) associated with the particular LCG associated with the device to the base station 108 based at least in part on the results of determining whether the current buffer status value associated with the base-station BSR for the particular LCG (e.g., a current updated buffer status value after an uplink allocation) is at the defined value and/or determining whether the previous buffer status value associated with the base-station BSR for the particular LCG (e.g., previously updated buffer status value that was updated based at least in part on the previous BSR) was a non-zero value or was representative of a non-zero value and/or determining whether a buffer status index value (e.g., contained in the previous BSR) is representative of a non-zero value (e.g., in accordance with the enhanced BSR protocol), such as described herein. For instance, if the BSR manager component 204 (e.g., employing the BSR indicator generator component 208) determines that the current buffer status value associated with the base-station BSR for the particular LCG (e.g., a current updated buffer status value after an uplink allocation) is the defined value and/or determines that the previous buffer status value associated with the base-station BSR for the particular LCG was a non-zero value or was representative of a non-zero value and/or determines that the buffer status index value (e.g., contained in the previous BSR) is representative of a non-zero value, the BSR manager component 204 can determine that the BSR indicator is to be set to the send-report indicator value (e.g., in accordance with the enhanced BSR protocol), such as described herein.

In some embodiments, the communication manager component 116 can include the BSR indicator, which can indicate whether the device (e.g., device 110 or device 112) is to communicate the BSR to the base station 108, in a message (e.g., uplink DCI message comprising an uplink grant) that can be communicated to the device, in accordance with the defined communication management criteria and the enhanced BSR protocol. For example, the communication manager component 116 can generate the message, which can comprise the uplink grant, associated resources, and the BSR indicator, and the base station 108 can communicate the message to the device.

With regard to the device communication manager component 118 of the device (e.g., device 110 or device 112), the device communication manager component 118 (e.g., employing the device BSR manager component 304) can determine whether the device is to communicate a BSR report (e.g., a dynamic or on-demand BSR) associated with the particular LCG and the device to the base station 108 based at least in part on the result of an analysis of a BSR indicator, which can be included in a message (e.g., uplink DCI message comprising an uplink grant) received by the device from the base station 108 (e.g., in accordance with the enhanced BSR protocol). For example, if, based at least in part on the analysis results, the device BSR manager component 304 determines that the BSR indicator is set to a send-report value (e.g., dynamic or on-demand BSR=true), the device BSR manager component 304 can determine that the device is to communicate the BSR report associated with the particular LCG and the device to the base station 108, in accordance with the defined communication management criteria and the enhanced BSR protocol, such as described herein. If, instead, based at least in part on the analysis results, the device BSR manager component 304 determines that the BSR indicator is set to a no-report value (e.g., dynamic or on-demand BSR=false), the device BSR manager component 304 can determine that the device is not to communicate the BSR report associated with the particular LCG and the device to the base station 108, in accordance with the defined communication management criteria and the enhanced BSR protocol, such as described herein.

It is to be appreciated and understood that, while some aspects and embodiments are described with regard to one LCG, in certain embodiments, the enhanced techniques and enhanced protocols described herein and employed by the communication manager component 116 and/or the device communication manager component 118 can be utilized to manage and perform, or facilitate performance of, instructing, requesting, or notifying the devices (e.g., devices 110 and/or 112) to communicate BSRs (e.g., dynamic or on-demand BSRs) to the base station 108, and communication of BSRs by the devices with regard to one or more respective LCGs associated with one or more respective devices and/or one or more respective applications or services, concurrently, simultaneously, or in parallel. It also is to be appreciated and understood that, in some embodiments, the device 112 also can comprise an application component that can be same as or similar to the application component 114 of the device 110, and a device communication manager component 118 that can be same as or similar to the device communication manager component 118 of the device 110.

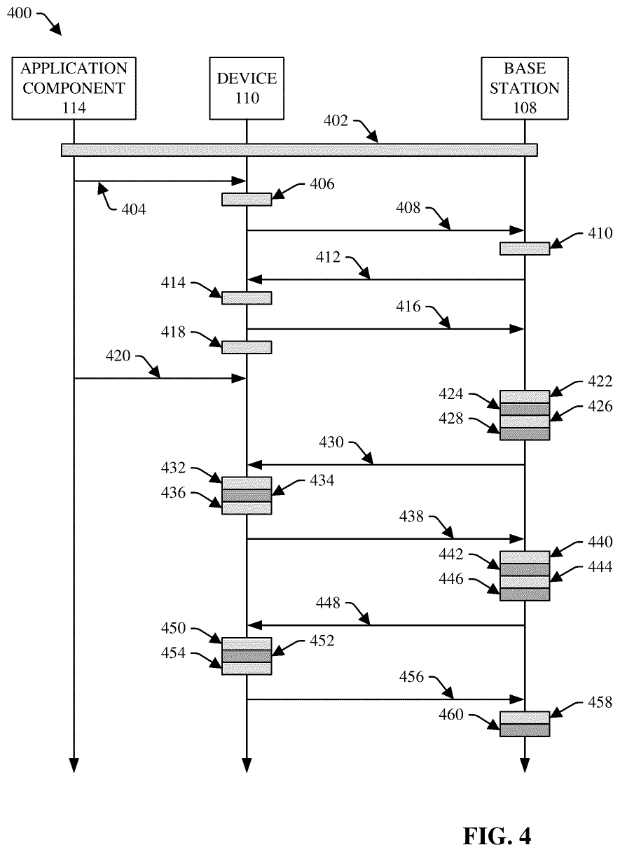

Referring to FIG. 4 (along with FIGS. 1, 2, and 3), FIG. 4 illustrates a block diagram of a non-limiting example process flow 400 that can desirably (e.g., automatically, dynamically, suitably, reliably, efficiently, enhancedly, and/or optimally) manage and perform, or facilitate performance of, instructing, requesting, or notifying a device to communicate BSRs (e.g., dynamic or on-demand BSRs), and communication of BSRs by the device, in accordance with various aspects and embodiments of the disclosed subject matter. In some embodiments, the components presented in connection with the process flow 400 can be part of the system 100 as shown in FIG. 1 and described herein.

As indicated at reference numeral 402 of the example process flow 400, the device 110 can be RRC connected with one DRB associated with (e.g., belonging to) LCG=1. It is to be appreciated and understood that, in certain embodiments, the device 110 can be associated with one or more DRBs that can be associated with one or more respective LCGs.

As indicated at reference numeral 404, the device 110 can receive a first amount of data from the application component 114 (e.g., an application of the application component 114), wherein the first amount of data can be available for communication to the base station 108. The first amount of data can be stored in the buffer component 302, for example, while awaiting communicating to the base station 108. In an example scenario, the first amount of data can be five PDUs of 1000 bytes each (e.g., PDU1, PDU2, PDU3, PDU4, and PDU5), although in other scenarios, the first amount of data can be different and/or the number of bytes of data per PDU can be different and/or varied. With the first amount of data (e.g., first uplink data) having arrived at the device 110 (e.g., at the buffer component 302 of the device) for LCG-1, the BSR for LCG-1 can change from zero and can be equal to the first amount of data (e.g., 5000 bytes, in the example scenario).

As indicated at reference numeral 406 of the example process flow 400, the regular BSR trigger can be active due in part to the BSR for LCG-1 changing from zero to non-zero, the device 110 may not have uplink allocation at this point, and the device 110 can trigger (e.g., initiate and/or generate) a scheduling request to facilitate obtaining uplink allocation from the base station 108 as the regular BSR can be pending, in accordance with the BSR protocol. As indicated at reference numeral 408, the device 110 can communicate the scheduling request to the base station 108 to facilitate obtaining uplink allocation from the base station 108.

As indicated at reference numeral 410 of the example process flow 400, the base station 108 (e.g., the DU of the base station 108), employing the grant allocator component 202 of the communication manager component 116, can allocate an uplink grant and associated resources to allow (e.g., enable) the device 110 to communicate at least a BSR to the base station 108. In connection with the uplink grant, the BSR indicator generator component 208 can determine that the BSR indicator is to be set to a no-report value (e.g., dynamic or on-demand BSR=false), which can indicate that the device 110 is not to communicate a dynamic BSR to the base station 108. For instance, the BSR indicator generator component 208 can determine and set the BSR indicator to have the no-report value, since the device 110 already can be preparing to communicate the regular BSR, in response to the scheduling request, and in accordance with the uplink grant. The base station 108 can generate an uplink DCI message that can comprise information (e.g., uplink DCI) relating to the uplink grant, the associated resources, and the BSR indicator that can have the no-report value. As indicated at reference numeral 412, the base station 108 can communicate the uplink DCI message to the device 110 to allow the device 110 to at least communicate the BSR to the base station 108.

As indicated at reference numeral 414 of the example process flow 400, the device 110, employing the device BSR component 306 (e.g., of the device communication manager component 118), can generate a first BSR for LCG=1, wherein the first BSR can comprise a first buffer status index value that can be determined based at least in part on the first amount of data and can correspond to a second amount of data. The second amount of data typically can be greater than or equal to the first amount of data, although there can be an instance where the second amount of data may not be greater than or equal to the first amount of data (e.g., if the first amount of data corresponds to a value (e.g., a number of other value) that can be greater than a maximum buffer status index value). For instance, the device BSR component 306 can determine the first amount of data associated with LCG-1 that can be available for communication to the base station 108 based at least in part on the results of analyzing information relating to data in the buffer component 302 and/or analyzing the data in the buffer component 302. For example, the device BSR component 306 can determine the first buffer status index value, based at least in part on the first amount of data, such that the first buffer status index value can correspond to (e.g., can be mapped to, can indicate, or can otherwise correspond to) the second amount of data that can be greater than or equal to the first amount of data. For instance, in the example scenario, with 5000 bytes of data associated with LCG-1 being available in the buffer component 302, the device BSR component 306 can determine that the first buffer status index value can be 20, which can correspond to (e.g., can be mapped to, can indicate, or can otherwise correspond to) 5446 bytes of data, in accordance with the defined BSR protocol. In the example scenario, the device BSR component 306 can determine and select the buffer status index value of 20, rather than 19, for example, since the buffer status index value of 19 can correspond to 3909 bytes of data, which is less than the 5000 bytes available in the buffer component 302, and the buffer status index value of 20 can correspond to more than 5000 bytes, in accordance with the defined BSR protocol. In some embodiments, the BSR indicator evaluator component 308 can determine that a dynamic BSR is not to be communicated to the base station 108, based at least in part on the BSR indicator having the no-report value (e.g., and since the device 110 already is communicating a regular BSR to the base station, in accordance with the uplink grant and the scheduling request).

As indicated at reference numeral 416, the device 110 can communicate an uplink message (e.g., an uplink MAC PDU message), which can comprise the first BSR, to the base station 108, wherein the first BSR can comprise the first buffer status index value for LCG-1 (e.g., BSR(LCG=1, buffer status (BS)=20)). As indicated at reference numeral 418, the device 110, employing the BSR timer component 310, can restart (e.g., reset, reinitiate) the periodic BSR and the retx BSR timer (e.g., associated with LCG-1), in accordance with the defined BSR protocol. The periodic BSR and the retx BSR timer can have respective timer values (e.g., respective amounts of time for the respective times).

As indicated at reference numeral 420 of the example process flow 400, the device 110 can receive a third amount of data associated with LCG-1 from the application component 114 (e.g., the application of the application component 114), wherein the third amount of data can be available for communication to the base station 108. The third amount of data can be stored in the buffer component 302, for example, while awaiting communicating to the base station 108. For instance, in the example scenario, the third amount of data can be four PDUs of 1000 bytes of data each (e.g., PDU6, PDU7, PDU8, and PDU9), although in other scenarios, the third amount of data can be different and/or the number of bytes of data per PDU can be different and/or varied. With the third amount of data having arrived at the device 110 (e.g., at the buffer component 302 of the device) for LCG-1, the BSR for LCG-1 can be equal to the total of the first amount of data and the third amount of data (e.g., 9000 bytes of data, in the example scenario).

As indicated at reference numeral 422 of the example process flow 400, the base station 108, employing the BSR update component 210, can update a base-station BSR for LCG-1 (e.g., associated with the base station 108 (e.g., the DU of the base station 108) and the device 110) to a first buffer status value to correspond to the first buffer status index value contained in the first BSR, based at least in part on the results of analyzing the information in the first BSR, including the first buffer status index value. For instance, in the example scenario, if the first buffer status index value is 20, which can correspond to 5446 bytes of data, the BSR update component 210 can update a base-station BSR for LCG-1 to a first buffer status value that can be 5446 bytes (or a value that can be representative of 5446 bytes), which can correspond with the first buffer status index value of 20, in accordance with the defined BSR protocol.

As indicated at reference numeral 424, the base station 108, employing the grant allocator component 202 of the communication manager component 116, can allocate an uplink grant and associated resources to allow (e.g., enable) the device 110 to communicate up to a fourth amount of data to the base station 108, based at least in part on the results of analyzing the first buffer status value of the base-station BSR for LCG-1, which can correspond to the first buffer status index value, wherein the fourth amount of data can be greater than or equal to the second amount of data. For instance, in the example scenario, the grant allocator component 202 can allocate an uplink grant and associated resources to allow the device 110 to communicate up to 6000 bytes of data to the base station 108, based at least in part on the results of analyzing the first buffer status value (e.g., 5446 bytes or a value representative of 5446 bytes) of the base-station BSR for LCG-1, which can correspond to the first buffer status index value, wherein the allocation of 6000 bytes can be greater than the 5446 bytes that can be determined from the first buffer status value.

As indicated at reference numeral 426, with the uplink grant allocation completed, the BSR update component 210 can update the base-station BSR for LCG-1 to a second buffer status value, such as, for example, 0 bytes, since the uplink grant can allow the device 110 to communicate up to the fourth amount of data (e.g., 6000 bytes), which can be greater than or equal to the first buffer status value (e.g., 5446 bytes or a value representative of 5446 bytes) of the base-station BSR for LCG-1. As indicated at reference numeral 428, the BSR indicator generator component 208 can determine that the BSR indicator value is to be set to the send-report value (e.g., dynamic or on-demand BSR=true), which can indicate that the device 110 is to communicate a dynamic BSR to the base station 108. For instance, the BSR indicator generator component 208 can determine and set the BSR indicator to have the send-report value, based at least in part on determining that the base-station BSR (e.g., the second buffer status value of the base-station BSR) for LCG-1 is at the defined value (e.g., 0 bytes), which can indicate that it can be desired (e.g., wanted, useful, or optimal) for the device 110 to communicate the dynamic BSR to the base station 108, in accordance with the defined communication management criteria and the enhanced BSR protocol. In certain embodiments, if the BSR indicator generator component 208 determines that the current (e.g., second) buffer status value associated with the base-station BSR is the defined value and/or determines that the previous (e.g., first) buffer status value associated with the base-station BSR for LCG-1 was a non-zero value or was representative of a non-zero value, and/or determines that the first buffer status index value is representative of a non-zero value, the BSR indicator generator component 208 can determine that the BSR indicator value is to be set to the send-report indicator value (e.g., in accordance with the defined communication management criteria and the enhanced BSR protocol). The base station 108 can generate an uplink DCI message that can comprise information (e.g., uplink DCI) relating to the uplink grant, the associated resources, and the BSR indicator that can have the send-report value (e.g., dynamic or on-demand BSR=true), which can indicate that the device 110 is to communicate a dynamic BSR to the base station 108.

As indicated at reference numeral 430 of the example process flow 400, the base station 108 can communicate the uplink DCI message to the device 110 to allow the device 110 to communicate up to the fourth amount of data (e.g., up to 6000 bytes of data, in the example scenario) to the base station 108 and have the device 110 communicate a second BSR (e.g., a dynamic BSR) to the base station 108. The device 110 can receive the uplink DCI message from the base station 108.

As indicated at reference numeral 432 of the example process flow 400, the BSR indicator evaluator component 308 can determine that a second BSR (e.g., dynamic BSR) is to be communicated to the base station 108, based at least in part on the results of an analysis of the BSR indicator in the uplink DCI message, wherein the BSR indicator can have the send-report value. As indicated at reference numeral 434, the device communication manager component 118 can determine that the device 110 can communicate up to the fourth amount of data to the base station 108, in accordance with the uplink grant. The device communication manager component 118 also can determine there can be a total of the first amount of data and the third amount of data in the buffer component 302 (e.g., a total of 9000 bytes, in the example scenario) and available to communicate to the base station 108, based at least in part on the BSR (e.g., the current buffer status value of the BSR) for LCG-1 associated with the device 110. The device communication manager component 118 further can determine that, since the total of the first amount of data and the third amount of data is available for communication to the base station 108, and since the second BSR is to be communicated to the base station 108, the device 110 can communicate a fifth amount of data and the second BSR to the base station 108. For instance, in the example scenario, the device communication manager component 118 can determine that the device 110 can communicate five PDUs (e.g., 5000 bytes of data comprising PDU1, PDU2, PDU3, PDU4, and PDU 5) and a portion (e.g., segment) of the sixth PDU (e.g., 992 bytes of data) that can be available in the buffer component 302, and the second BSR (e.g., 8 bytes of data), for a total of 6000 bytes of data, in accordance with the uplink grant.

As indicated at reference numeral 436, the device BSR component 306 can generate the second BSR, comprising a second buffer status index value, based at least in part on a sixth amount of data associated with the LCG-1 that can remain available in the buffer component 302 for communication to the base station 108. For example, the device BSR component 306 can determine the second buffer status index value that can be included in the second BSR, based at least in part on the sixth amount of data (e.g., 3008 bytes of data, in the example scenario) that can remain available in the buffer component 302 for communication to the base station 108, wherein the second buffer status index value can be representative of a seventh amount of data that can be greater than or equal to the sixth amount of data. For instance, in the example scenario, the device BSR component 306 can determine and select the buffer status index value (e.g., second buffer status index value) of 19, since the buffer status index value of 19 can correspond to 3909 bytes of data (e.g., the seventh amount of data), which can be more than, and sufficient to communicate, the 3008 bytes of data remaining in the buffer component 302, in accordance with the defined BSR protocol, as a buffer status index value of 18 can correspond to 2806 bytes of data, which is less than the 3008 bytes of data that remain in the buffer component 302.

As indicated at reference numeral 438 of the example process flow 400, the device 110 (e.g., employing the device communication manager component 118) can communicate an uplink message (e.g., uplink MAC message), which can comprise the fifth amount of data and the second BSR (e.g., uplink MAC PDU(PDU1, PDU2, PDU3, PDU4, PDU5, segmented PDU6(992 bytes), BSR(LCG-1, BS=19), in the example scenario), to the base station 108. The base station can receive the uplink message from the device 110.

As indicated at reference numeral 440 of the example process flow 400, the base station 108, employing the BSR update component 210, can update the base-station BSR for LCG-1 (e.g., associated with the base station 108 (e.g., the DU of the base station 108) and the device 110) to a third buffer status value to correspond to the second buffer status index value contained in the second BSR and representative of the seventh amount of data, based at least in part on the results of analyzing the information in the second BSR, including the second buffer status index value. For instance, in the example scenario, if the second buffer status index value is 19, which can correspond to 3909 bytes of data, the BSR update component 210 can update the base-station BSR for LCG-1 to a third buffer status value that can be 3909 bytes (or a value that can be representative of 3909 bytes), which can correspond with the second buffer status index value of 19, in accordance with the defined BSR protocol.

As indicated at reference numeral 442, the base station 108, employing the grant allocator component 202 of the communication manager component 116, can allocate an uplink grant and associated resources to allow (e.g., enable) the device 110 to communicate up to an eighth amount of data to the base station 108, based at least in part on the results of analyzing the third buffer status value of the base-station BSR for LCG-1, which can correspond to the second buffer status index value, wherein the eighth amount of data can be greater than or equal to the seventh amount of data. For instance, in the example scenario, the grant allocator component 202 can allocate an uplink grant and associated resources to allow the device 110 to communicate up to the eighth amount of data (e.g., 4000 bytes of data) to the base station 108, based at least in part on the results of analyzing the third buffer status value (e.g., 3909 bytes or a value representative of 3909 bytes) of the base-station BSR for LCG-1, which can correspond to the second buffer status index value (e.g., 19), wherein the allocation of 4000 bytes can be greater than the 3909 bytes that can be determined from the third buffer status value of the base-station BSR for LCG-1.

As indicated at reference numeral 444, with the uplink grant allocation completed, the BSR update component 210 can update the base-station BSR for LCG-1 to a fourth buffer status value, such as, for example, 0 bytes, since the uplink grant can allow the device 110 to communicate up to the eighth amount of data (e.g., 4000 bytes), which can be greater than or equal to the third buffer status value (e.g., 3909 bytes or a value representative of 3909 bytes) of the base-station BSR for LCG-1. The uplink grant to allow the device 110 to communicate at least the eighth amount of data (e.g., 4000 bytes) can be desirable and sufficient to enable the device 110 to communicate at least the seventh amount of data (e.g., 3909 bytes or a value representative of 3909 bytes) indicated by the second buffer status index value (and the actual remaining amount of data (e.g., 3008 bytes of data) stored in the buffer component 302 of the device 110 and available for communication to the base station 108).

As indicated at reference numeral 446, the BSR indicator generator component 208 can determine that the BSR indicator value is to be set to the send-report value (e.g., dynamic or on-demand BSR=true), which can indicate that the device 110 is to communicate a dynamic BSR to the base station 108. For instance, the BSR indicator generator component 208 can determine and set the BSR indicator to have the send-report value, based at least in part on determining that the base-station BSR (e.g., the fourth buffer status value of the base-station BSR) for LCG-1 is at the defined value (e.g., 0 bytes), which can indicate that it can be desired (e.g., wanted, useful, or optimal) for the device 110 to communicate the dynamic BSR to the base station 108, in accordance with the defined communication management criteria and the enhanced BSR protocol. In certain embodiments, if the BSR indicator generator component 208 determines that the current (e.g., fourth) buffer status value associated with the base-station BSR is the defined value and/or determines that the previous (e.g., third) buffer status value associated with the base-station BSR was a non-zero value or was representative of a non-zero value, and/or determines that the second buffer status index value is representative of a non-zero value, the BSR indicator generator component 208 can determine that the BSR indicator value is to be set to the send-report indicator value (e.g., in accordance with the defined communication management criteria and the enhanced BSR protocol). The base station 108 can generate an uplink DCI message that can comprise information (e.g., uplink DCI) relating to the uplink grant, the associated resources, and the BSR indicator that can have the send-report value (e.g., dynamic or on-demand BSR=true), which can indicate that the device 110 is to communicate a dynamic BSR to the base station 108.

As indicated at reference numeral 448 of the example process flow 400, the base station 108 can communicate the uplink DCI message to the device 110 to allow the device 110 to communicate up to the eighth amount of data (e.g., up to 4000 bytes of data, in the example scenario) to the base station 108 and have the device 110 communicate a third BSR (e.g., a dynamic BSR) to the base station 108. The device 110 can receive the uplink DCI message from the base station 108.

As indicated at reference numeral 450 of the example process flow 400, the BSR indicator evaluator component 308 can determine that a third BSR (e.g., dynamic BSR) is to be communicated to the base station 108, based at least in part on the results of an analysis of the BSR indicator in the uplink DCI message, wherein the BSR indicator can have the send-report value. As indicated at reference numeral 452, the device communication manager component 118 can determine that the device 110 can communicate up to the eighth amount of data to the base station 108, in accordance with the uplink grant. The device communication manager component 118 also can determine there can be the sixth amount of data (e.g., the remaining 3008 bytes of data, in this example scenario) in the buffer component 302 and available to communicate to the base station 108, based at least in part on the BSR (e.g., the current buffer status value of the BSR) for LCG-1 associated with the device 110. The device communication manager component 118 further can determine that, since the sixth amount of data is available for communication to the base station 108 and the sixth amount of data is less than the eighth amount of data allowed by the uplink grant, and since the third BSR is to be communicated to the base station 108, the device 110 can communicate the sixth amount of data and the third BSR to the base station 108. For instance, in the example scenario, the device communication manager component 118 can determine that the device 110 can communicate three PDUs (e.g., 3000 bytes of data comprising PDU7, PDU8, and PDU 9) and the remaining portion (e.g., remaining segment) of the sixth PDU (e.g., 8 bytes of data) that can be available in the buffer component 302, and the third BSR (e.g., 8 bytes of data), for a total of 3016 bytes of data, in accordance with the uplink grant.

As indicated at reference numeral 454, the device BSR component 306 can generate the third BSR, comprising a third buffer status index value, based at least in part on there being no data associated with the LCG-1 that remains available in the buffer component 302 for communication to the base station 108. For example, the device BSR component 306 can determine the third buffer status index value that can be included in the third BSR, based at least in part on determining that there is no data (e.g., a buffer status value of 0) associated with the LCG-1 that remains available in the buffer component 302 for communication to the base station 108, wherein the third buffer status index value can be representative of a zero amount of data. For instance, in the example scenario, the device BSR component 306 can determine and select the buffer status index value (e.g., third buffer status index value) of 0, since the buffer status index value of 0 can correspond to 0 bytes of data (e.g., the buffer status value of 0) associated with LCG-1 remaining available for communication to the base station 108 (e.g., since the 3008 bytes of data is already being prepared for communication to the base station 108), in accordance with the defined BSR protocol.

As indicated at reference numeral 456 of the example process flow 400, the device 110 (e.g., employing the device communication manager component 118) can communicate an uplink message (e.g., uplink MAC message), which can comprise the sixth amount of data and the third BSR (e.g., uplink MAC PDU(remaining segment PDU6(8 bytes), PDU7, PDU8, PDU9, BSR(LCG-1, BS=0), in the example scenario), to the base station 108. The base station can receive the uplink message from the device 110.

As indicated at reference numeral 458 of the example process flow 400, the base station 108, employing the BSR update component 210, can update the base-station BSR for LCG-1 (e.g., associated with the base station 108 (e.g., the DU of the base station 108) and the device 110) to a fifth buffer status value that can correspond to the third buffer status index value contained in the third BSR, based at least in part on the results of analyzing the information in the third BSR, including the third buffer status index value. For instance, in the example scenario, if the third buffer status index value is 0, which can correspond to 0 bytes of data, the BSR update component 210 can update the base-station BSR for LCG-1 to a fifth buffer status value that can be 0 bytes (or a value that can be representative of 0 bytes), which can correspond with the third buffer status index value of 0, in accordance with the defined BSR protocol.

As indicated at reference numeral 460 of the example process flow 400, in the example scenario, the base station 108, employing the grant allocator component 202 or other component of the communication manager component 116, can determine that uplink allocation associated with LCG-1 for the device 110 can be discontinued (e.g., stopped or ceased), and can discontinue the uplink allocation associated with LCG-1 for the device 110, based at least in part on determining that the fifth buffer status value of the base-station BSR for LCG-1 is 0 bytes (and/or the third buffer status index value is 0). For instance, since it can be determined that the device 110 does not have any available data associated with LCG-1 remaining for communication to the base station 108, at least at this time, the base station 108, employing the grant allocator component 202 or other component of the communication manager component 116, can determine that uplink allocation associated with LCG-1 for the device 110 can be discontinued, and can discontinue such uplink allocation associated with LCG-1 for the device 110.

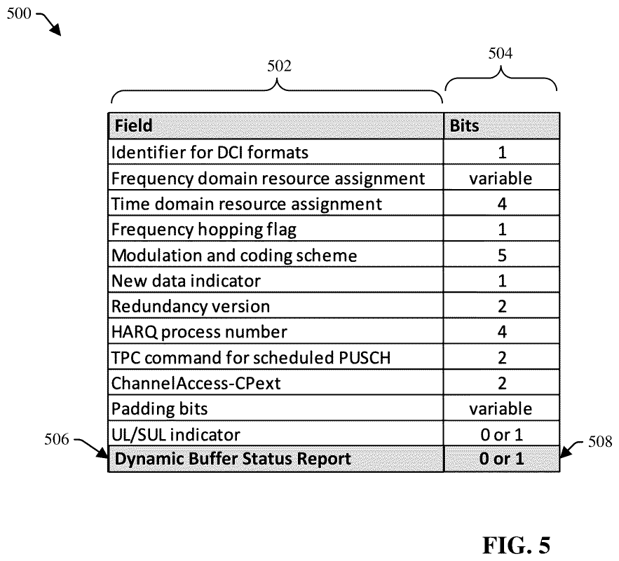

Referring to FIG. 5 (along with FIGS. 1, 2, and 3), FIG. 5 depicts a diagram of a non-limiting example enhanced uplink DCI format 500 that can desirably (e.g., usefully, enhancedly, or optimally) facilitate communication of BSR indicators to devices using uplink DCI to facilitate indicating whether the devices are to communicate dynamic (e.g., on-demand) BSRs to a base station, in accordance with various aspects and embodiments of the disclosed subject matter. In some embodiments, the example enhanced uplink DCI format 500 can be an enhanced uplink DCI_0_0 format, in accordance with the enhanced BSR protocol (and associated enhanced uplink DCI protocol). The example enhanced uplink DCI format 500 can comprise a group of fields 502, comprising respective fields relating to respective DCI-related items. The respective fields of the respective DCI items can utilize or accommodate respective numbers of bits 504 (e.g., bits of data, such as data values), wherein respective data bit values can indicate respective attributes (e.g., characteristics or properties) of the respective DCI items.

Some of the respective fields of the group of fields 502 can relate to, for example, an identifier for DCI formats, a frequency domain resource assignment, a time domain resource assignment, a frequency hopping flag, a modulation and coding scheme, a new data indicator, a redundancy version, a hybrid automatic repeat request (HARQ) process number, a transmission power control (TPC) command for scheduled physical uplink shared channel (PUSCH), a channel access type and cyclic prefix (CP) extension (ChannelAccess-CPext), padding bits, and an uplink (UL)/supplementary UL (SUL) indicator. In some embodiments, a dynamic BSR field 506 of the group of fields 502 can relate to a dynamic BSR, in accordance with the enhanced BSR protocol (and associated enhanced uplink DCI protocol). In certain embodiments, the dynamic BSR field 506 can utilize or accommodate a desired number of bits 508 (e.g., 1 bit or other desired number of bits of data), wherein the bit value of the dynamic BSR field 506 in the uplink DCI message can be a BSR indicator value that can indicate whether a device is to communicate a dynamic BSR to a base station, in accordance with the enhanced BSR protocol (and associated enhanced uplink DCI protocol). For example, a first BSR indicator value (e.g., 1 or other desired value) can indicate that the device is to communicate a dynamic BSR to the base station, and a second BSR indicator value (e.g., 0 or other desired value different from the first BSR indicator value) can indicate that the device is not to communicate a dynamic BSR to the base station. In some embodiments, the respective fields of the group of fields 502, and the respective field values of the respective fields, can be in a defined order, in accordance with the enhanced BSR protocol (and associated enhanced uplink DCI protocol).

It is to be appreciated and understood that, while the example enhanced uplink DCI format 500 can depict the enhanced uplink DCI_0_0 format, in accordance with various embodiments, the disclosed subject matter, and the communication manager component 116 and device communication manager component 118, can generate and/or utilize one or more other enhanced uplink DCI formats that can desirably (e.g., usefully, enhancedly, or optimally) facilitate communication of BSR indicators to devices using uplink DCI to facilitate indicating whether the devices are to communicate dynamic BSRs to a base station. For instance, similar to the enhanced uplink DCI_0_0 format, the disclosed subject matter, and the communication manager component 116 and device communication manager component 118, can generate and/or utilize an enhanced uplink DCI_0_1 format, an enhanced uplink DCI_0_2 format, an enhanced uplink DCI_0_3 format, or other enhanced uplink DCI format that can comprise respective fields, relating to respective DCI-related items, that can utilize or accommodate respective numbers of bits, wherein the respective fields of each of the enhanced uplink DCI_0_1 format, enhanced uplink DCI_0_2 format, enhanced uplink DCI_0_3 format, or other enhanced uplink DCI format can comprise a dynamic BSR field that can utilize or accommodate a desired number of bits (e.g., 1 bit or another desired number of bits) that can desirably (e.g., usefully, enhancedly, or optimally) facilitate communication of BSR indicators to devices using uplink DCI to facilitate indicating whether the devices are to communicate dynamic BSRs to a base station, in accordance with the enhanced BSR protocol (and associated enhanced uplink DCI protocol).

With further regard to FIG. 2 and the AI component 212, in accordance with various embodiments, the AI component 212 and/or the model 216 can perform an AI-based analysis on data, such as information relating to communication sessions, data traffic, BSRs, BSR indicators, buffer statuses of devices, buffer status index values, applications, services, attributes, conditions, operations, functions, parameters, events, and/or other features associated with the RAN 106 and/or devices (e.g., device 110 and/or device 112), and/or the core network 104, and/or feedback information (e.g., feedback information from a user, a device, a base station (e.g., base station 108), network equipment or network function of the core network 104, or another data source). In some embodiments, with regard to a model 216, the AI component 212 can input such information into the (trained) model 216 for analysis (e.g., AI-based analysis) by the model 216 to update the model 216 or to generate output results (e.g., AI-related data relating to uplink grants and allocations, BSR indicators, BSRs, and/or other output results) based at least in part on the analysis of the input information.

In connection with or as part of such an AI-based analysis, the AI component 212 can employ, build (e.g., construct or create), and/or import, AI-based techniques and algorithms, AI-based models 216 (e.g., untrained or trained models), neural networks (e.g., untrained or trained neural networks), decision trees, Markov chains (e.g., trained Markov chains), and/or graph mining to render and/or generate predictions, inferences, calculations, prognostications, estimates, derivations, forecasts, detections, and/or computations that can facilitate determining or learning data patterns in data, determining or learning a correlation, relationship, or causation between an item(s) of data and another item(s) of data (e.g., occurrence of the other item(s) of data or an event relating thereto), determining or learning a correlation, relationship, or causation between an event and another event (e.g., occurrence of another event), determining or learning about patterns of communication of data associated with applications, services, and/or devices, determining or learning about patterns of buffer statuses of devices in relation to applications and/or services, determining or learning about patterns of communication of BSRs by devices in relation to applications, services, and/or data communications, determining or learning about patterns of communication of BSR indicators to instruct or request devices to communicate BSRs in relation to applications, services, devices, and/or data communications, determining or learning about data traffic associated with communication sessions between the RAN 106 and devices (e.g., 110 or 112), performing other desired functions or operations, and/or automating one or more functions or features of the disclosed subject matter, as more fully described herein.

The AI component 212 can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein with regard to the disclosed subject matter, the AI component 212 can examine the entirety or a subset of the data (e.g., the training data; the operational data relating to the communication network 102, the core network 104, a device (e.g., device 110 and/or device 112), the RAN 106, a base station (e.g., base station 108), and/or the services; the feedback information; and/or other information, such as described herein) to which it is granted access and can provide for reasoning about or determine states of the system and/or environment from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

In some embodiments, with regard to probabilities, the AI component 212 and/or the trained model(s) 216 can employ one or more threshold probabilities (e.g., threshold probability values) to facilitate making a determination. For instance, in making a determination (e.g., a determination of whether to communicate a BSR indicator to instruct or request a device to communicate a dynamic BSR to the base station, or other determination), as part of the AI-based analysis of information, the AI component 212 and/or the trained model(s) 216 can determine a probability (e.g., a probability that a buffer status of the device indicates that the device has data available in its buffer component to communicate to the base station, or other probability), and can determine whether the probability (e.g., probability value) satisfies (e.g., meets or exceeds; or is at or greater than) a defined and applicable threshold probability. The AI component 212 and/or the trained model(s) 216 can make a determination (or prediction or inference) (e.g., a determination (or prediction or inference) of whether to communicate a BSR indicator to instruct or request a device to communicate a dynamic BSR to the base station, or other determination) based at least in part on the results of analyzing (e.g., comparing) the probability to the defined and applicable threshold probability (e.g., threshold minimum probability value). As a non-limiting example, the AI component 212 and/or the trained model(s) 216 can make a determination (or prediction or inference) that the device has data available in its buffer component to communicate to the base station, and the base station is to communicate a BSR indicator to instruct or request the device to communicate a dynamic BSR to the base station based at least in part on determining that a probability that the device has data available to communicate to the base station satisfies the defined and applicable threshold probability (e.g., the probability is the highest probability, relative to other probabilities relating to whether the device has data available in its buffer component to communicate to the base station, and satisfies the defined and applicable threshold probability). In other embodiments, the AI component 212 and/or the trained model(s) 216 can make a determination (or prediction or inference) that the device has data available in its buffer component to communicate to the base station based at least in part on determining that a probability that the device has data available to communicate to the base station is a highest probability relative to the other probabilities (e.g., a probability that the device does not have data available in its buffer component to communicate to the base station), without use of and/or without regard to a threshold probability.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes and/or systems (e.g., support vector machines, neural networks, expert systems, Bayesian belief networks, fuzzy logic, data fusion engines, and so on) in connection with performing automatic and/or determined action in connection with the claimed subject matter. Thus, classification schemes and/or systems can be used to automatically learn and perform a number of functions, actions, and/or determinations.

In some embodiments, the AI component 212 can employ a classifier that can perform an AI-based analysis on data. A classifier can map an input attribute vector, z=(z1, z2, z3, z4, . . . , zn), to a confidence that the input belongs to a class, as by f(z)=confidence(class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence, any of which can be employed. Classification as used herein also is inclusive of statistical regression that is utilized to develop models of priority.

In some embodiments, the AI component 212 (e.g., employing the trainer component 214) can comprise, generate, and/or train (e.g., iteratively train) AI-based models 216 that can be trained to learn, determine, predict, or infer data patterns in data; a correlation, relationship, or causation between an item(s) of data and another item(s) of data (e.g., occurrence of the other item(s) of data or an event relating thereto); a correlation, relationship, or causation between an event and another event (e.g., occurrence of another event); relationships between components (e.g., RAN 106, cells, network nodes, communication links, devices, or other components or functions) of or associated with the communication network 102; data traffic (e.g., type of data traffic, amount of data traffic, or other characteristic of data traffic) associated with communication sessions between the RAN 106 station and devices (e.g., device 110 and/or device 112, utilizing an application or service); patterns of communication of data associated with applications, services, and/or devices; patterns of buffer statuses of devices in relation to applications and/or services; patterns of communication of BSRs by devices in relation to applications, services, and/or data communications; and/or patterns of communication of BSR indicators to instruct or request devices to communicate BSRs in relation to applications, services, devices, and/or data communications; and/or to perform other desired functions or operations, and/or to automate one or more functions or features of the disclosed subject matter, as described herein.

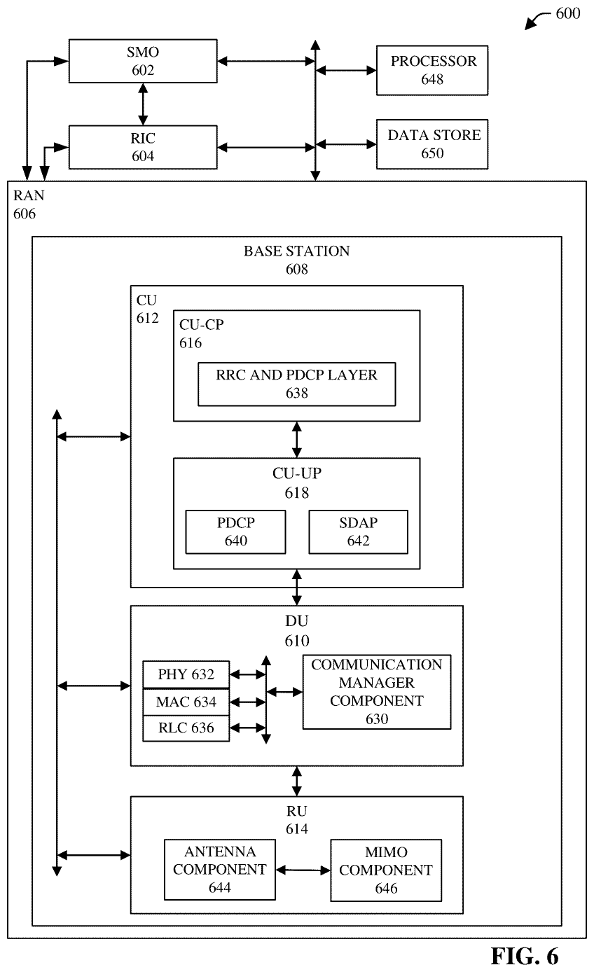

Turning to FIG. 6 (along with FIGS. 1 and 2), FIG. 6 depicts a block diagram of non-limiting example system 600 that can comprise the communication manager component in the RAN in an O-RAN communication network environment to facilitate desirable (e.g., suitable, reliable, efficient, enhanced, and/or optimal) management and performance of instructing, requesting, or notifying device to communicate BSRs (e.g., dynamic or on-demand BSRs) to the RAN, in accordance with various aspects and embodiments of the disclosed subject matter. In some embodiments, the system 600 can be part of the system 100 depicted in FIG. 1.

The system 600 can comprise a service management and orchestration (SMO) 602, a RIC 604, and a RAN 606. In some embodiments, the RAN 606 can be an O-RAN that can be part of an O-RAN architecture and environment (e.g., the communication network 102 can employ an O-RAN architecture and environment). In certain embodiments, the RAN 606 can be a cloud-based or centralized RAN (C-RAN) that can be part of a cloud or centralized RAN (C-RAN), or a virtual RAN (vRAN) that can be part of a vRAN architecture and environment (e.g., the communication network 102 can employ a C-RAN or vRAN architecture and environment). In still other embodiments, the RAN 606 may not be an O-RAN, C-RAN, or vRAN.

In accordance with various embodiments, the RAN 606 and associated communication network (e.g., communication network 102) can be part of a 5G or other new radio (NR) communication environment (e.g., an xG communication environment, wherein x can be 5 or a number greater than 5). In some embodiments, with regard to 5G or other NR generation, the RAN 606 can comprise base stations, such as a gNodeB (gNB or NR-NB), that can be disaggregated into a central unit (CU) (e.g., gNB or other NR-NB CU), comprising a CU-user plane (CU-UP) (e.g., gNB or other NR-NB CU-UP), a CU-control plane (CU-CP) (e.g., gNB or other NR-NB CU-CP), and a DU (e.g., gNB or other NR-NB DU). The CU-UP and DU can be part of the user plane node, with the CU-UP hosting PDCP and SDAP entities, and the DU can host the RLC, MAC, and PHY layers. For instance, the RAN 606 can comprise the base station 608 that can comprise a DU 610, a CU 612, and a radio unit (RU) 614 (e.g., a gNB or other NR-NB RU). The CU 612 can comprise a CU-CP 616 (also referred to as a CU-CP node) and a CU-UP 618 (also referred to as a CU-UP node). In certain embodiments, the RAN 606 and/or the base station 608 can comprise multiple DUs, multiple CU-CPs, multiple CU-UPs, and/or multiple RUs. In some embodiments, the DU 610, the CU 612, and the RU 614 can be co-located at a cell site. In other embodiments, the RAN 606 can be a disaggregated RAN where one or more of the components (e.g., the CU 612, or at least part of the CU 612, such as the CU-CP 616) of the base station 608 can be located in different location than one or more other components (e.g., DU 610, RU 614, and/or CU-UP 618) of the base station 608.

In accordance with various embodiments, the system 600 can comprise one or more processing units 620 that can be associated with (e.g., communicatively connected to or part of) the DU 610, the RU 614, and/or another component of or associated with the base station 608. In some embodiments, if the RAN 606 is a disaggregated RAN, the one or more processing units 620 (e.g., one or more CPUs or GPP-based servers) can be co-located with the DU 610 and/or other components of the RAN 606. The one or more processing units 620 can comprise the group of processing unit cores, which can comprise, for example, processing unit cores 622, 624, 626, and/or 628 that can function and operate as described herein.

In some embodiments, the system 600 also can comprise the communication manager component 630 that part of or can be associated with the DU 610 and/or other components of the RAN 606. The communication manager component 630 can comprise various components and functions, and can perform various operations, such as described herein. In certain embodiments, the communication manager component 630 can desirably manage and perform, or facilitate performance of, uplink grant allocations, and instructing, requesting, or notifying devices to communicate BSRs (e.g., dynamic or on-demand BSRs), in accordance with the defined communication management criteria and the enhanced BSR protocols, such as described herein.

The DU 610 can be a logical node that can host or handle baseband (e.g., physical layer (PHY) 632 (e.g., layer 1 (L1))) and layer 2 (L2) (e.g., a MAC layer 634 and a radio link control (RLC) layer 636) functionality associated with the base station 608. The CU-CP 616 can be a logical node that can host or handle layer 3 (L3) (e.g., an RRC and packet data convergence protocol (PDCP) layer 638) control plane functionality associated with the base station 608. The CU-UP 618 can be a logical node that can host or handle data traffic between the core network 104 (e.g., 5G core network) and one or more DUs (e.g., the DU 610) to which the CU-UP 618 is connected. In some embodiments, the CU-UP 618 can comprise a PDCP component (PDCP) 640 that can perform PDCP functions, and a service data adaptation protocol (SDAP) component (SDAP) 642 that can perform SDAP functions.

The RU 614 can be or can comprise a logical node that can host a lower PHY layer and radio frequency (RF) processing, where signals (e.g., RF signals) can be transmitted, received, amplified, digitized, or otherwise processed, to facilitate communication of information (e.g., signals comprising information) between the RAN 606 and other devices (e.g., devices 110 and/or 112) or components (e.g., components or functions of the core network 104 or communication network 102). In some embodiments, the RU 614 can comprise an antenna component 644 that can comprise an antenna array that can comprise a desired number of transmitter and receiver antennas to facilitate transmission and receiving of signals comprising information, and perform various beamforming, antenna-related, and communication-related functions. The RU 614 also can comprise a MIMO component 646 that can be employed to generate or modify a number of MIMO spatial layers and a number of spatial streams employed by the base station 608 (e.g., with regard to a device(s)) during a communication session between the base station 608 and a device (e.g., device 110), and perform MIMO spatial multiplexing functions. In certain embodiments, the MIMO component 646 can be configured in a single user (SU)-type MIMO mode or a multiple user (MU)-type MIMO mode. In some embodiments, the MIMO component 646 can employ or support massive MIMO (mMIMO). The RU 614 also can comprise or be associated with other functions, including, for example, modulation and coding scheme (MCS) functions and transmit diversity functions.

In some embodiments, as disclosed, the system 600 can comprise an O-RAN architecture and environment, and the RAN 606 can be an O-RAN. In some embodiments, in the O-RAN architecture and environment, the SMO component 602 can be associated with (e.g., communicatively connected to) the RIC 604 and/or the RAN 606 (and/or one or more other RANs) via an interface(s) (e.g., an O1 interface, an A1 interface, or another interface), to facilitate communication of information between the SMO component 602 and the RIC 604 and/or the RAN 606 (and/or one or more other RANs), and the RIC 604 can be associated with the RAN 606 (and/or one or more other RANs) via an interface(s) (e.g., an E2 interface or another interface), to facilitate communication of information between the RIC 604 and the RAN 606 (and/or one or more other RANs).

The SMO component 602 can act and operate as a management and orchestration layer that can control configuration and automation aspects of the RIC 604 and RAN elements of the RAN(s) 606. The SMO component 602 can comprise various types of management services and various network functions, comprising network management functions, which can include RAN-type or RAN-related functions, core management functions, transport management functions, network slice management functions (e.g., end-to-end network slice management functions), and/or other network management functions. In accordance with various embodiments, the network functions can be or can comprise physical network functions, virtualized network functions (e.g., virtual machines (VMs), containers, or other virtualized network functions). At least some of the various network functions (e.g., network management functions or other network functions) can operate in real time or near real time.

The RIC 604 can operate to control (e.g., manage) and enhance (e.g., improve or optimize) RAN functions and services of the RAN(s) 606. At least some of the various network functions and components of the RIC 604 can operate in real time or near real time, and some network functions and components of the RIC 604 may operate in non-real time.

In accordance with various embodiments, the system 600 can comprise a processor component 648 that can be associated with (e.g., communicatively connected to) and can work in conjunction with other components of the system 600, including the SMO component 602, the RIC 604, the RAN 606, the one or more processing units 620, the communication manager component 630, a data store 650, and/or other components of the system 600, to facilitate performing the various functions and operations of the system 600. The processor component 648 can employ one or more processors (e.g., one or more central processing units (CPUs)), accelerators, graphics processing units (GPUs), application-specific integrated circuits (ASICs), microprocessors, controllers, microcontrollers, or other processors) that can process information relating to data, files, services, applications, RANs, cells, communication network, core network, devices, users, data traffic, communication sessions (e.g., PDU or other communication sessions), BSRs, BSR indicators, buffer status index values, LCGs, enhanced BSR protocols, uplink grants and allocations, condition or measurement reports, AI/ML-based models, AI-related data, training data, feedback information, predictions, inferences, threshold (e.g., maximum, minimum, or other threshold) values, weight values, data processing operations, messages, notifications, alarms, alerts, preferences (e.g., user or client preferences), hash values, metadata, parameters, hyperparameters, traffic flows, tables, mappings, policies, the defined communication management criteria, algorithms (e.g., enhanced communication management algorithms, enhanced BSR management algorithms, AI algorithms, hash algorithms, data compression algorithms, data decompression algorithms, and/or other algorithm), interfaces, protocols, tools, and/or other information, to facilitate operation of the system 600, and control data flow between the system 600 and/or other components (e.g., network equipment, components, or functions, the communication network 102, the core network 104, another base station, a device (e.g., 110 or 112), a node, an application, a service, a user, or other entity) associated with the system 600.

The data store 650 can store data structures (e.g., user data, metadata), code structure(s) (e.g., modules, objects, hashes, classes, procedures) or instructions, information relating to data, files, services, applications, RANs, cells, communication network, core network, devices, users, data traffic, communication sessions (e.g., PDU or other communication sessions), BSRs, BSR indicators, buffer status index values, LCGs, enhanced BSR protocols, uplink grants and allocations, condition or measurement reports, AI/ML-based models, AI-related data, training data, feedback information, predictions, inferences, threshold (e.g., maximum, minimum, or other threshold) values, weight values, data processing operations, messages, notifications, alarms, alerts, preferences (e.g., user or client preferences), hash values, metadata, parameters, hyperparameters, traffic flows, tables, mappings, policies, the defined communication management criteria, algorithms (e.g., enhanced communication management algorithms, enhanced BSR management algorithms, AI algorithms, hash algorithms, data compression algorithms, data decompression algorithms, and/or other algorithm), interfaces, protocols, tools, and/or other information, to facilitate controlling or performing operations associated with the system 600. The data store 650 can comprise volatile and/or non-volatile memory, such as described herein. In an aspect, the processor component 648 can be functionally coupled (e.g., through a memory bus) to the data store 650 in order to store and retrieve information desired to operate and/or confer functionality, at least in part, to the SMO component 602, the RIC 604, the RAN 606, the one or more processing units 620, the communication manager component 630, the processor component 648, the data store 650, and/or other component of the system 600, and/or substantially any other operational aspects of system 600.

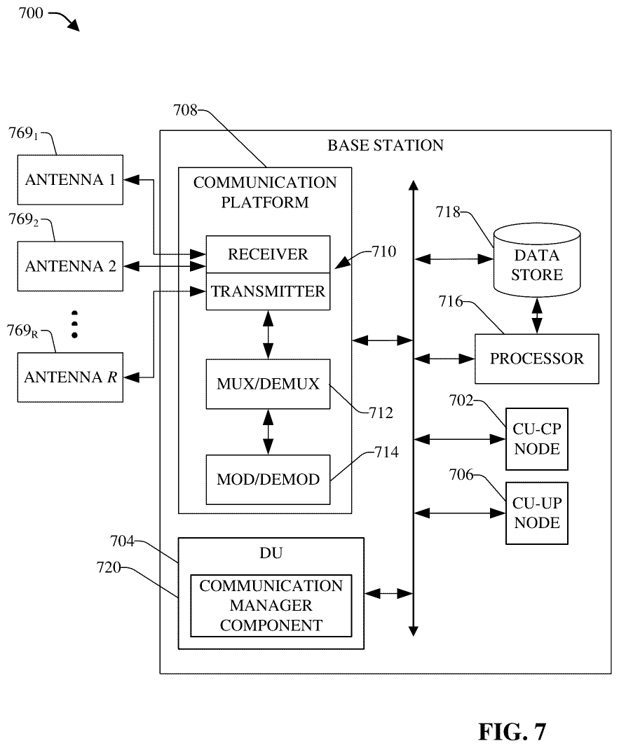

Turning to FIG. 7, FIG. 7 depicts a diagram of a non-limiting example base station 700 that can desirably facilitate (e.g., enable) connections (e.g., wireless connections) and communication of information associated with devices, in accordance with various aspects and embodiments of the disclosed subject matter. In some embodiments, the base station 700 can be a 5G or other NR base station (e.g., gNB or other NR-type or xG base station, wherein x can be a number greater than 5). In other embodiments, the base station 700 can be a 4G or LTE base station, can be a base station that can comprise 5G/NR functionality and 4G/LTE functionality, or can be some other type of base station (e.g., other type of access point).

With regard to a 5G or other NR base station, the base station 700 can comprise a CU-CP node 702 (e.g., a gNB or other NR-NB CU-CP node), one or more DUs (e.g., a gNB or other NR-NB DUs), including DU 704, a desired number of CU-UP nodes (e.g., a gNB or other NR-NB CU-UP nodes), including CU-UP node 706, and/or other network equipment. The CU-CP node 702 can be associated or interfaced with the DUs (e.g., DU 704) via an interface (e.g., F1-C interface) or connection. The CU-CP node 702 can be associated, or interfaced, with the CU-UP nodes (e.g., CU-UP node 706) via an interface (e.g., E1 interface) or connection. The one or more CU-UP nodes (e.g., CU-UP node 706) can be associated or interfaced with the one or more DUs (e.g., DU 704) via an interface (e.g., F1-U interface) or connection.

A DU (e.g., DU 704) can provide support for lower layers of a protocol stack. For instance, a DU (e.g., DU 704) can be a logical node that can host or handle baseband (e.g., PHY) and L2 (e.g., MAC and RLC layer) functionality associated with the base station 700. A CU-UP node (e.g., CU-UP node 706) can be a logical node that can host or handle data traffic between the core network 104 (e.g., 5G or other NR or xG core network) and the DU(s) (e.g., DU 704) to which the particular CU-UP is connected. The CU-CP node 702 can be a logical node that can host or handle L3 (e.g., RRC and PDCP layer) control plane functionality associated with the base station 700.

In some embodiments, a device(s) (e.g., device(s) 110 and/or 112) can be connected to the base station 700, via the DU 704, wherein the CU-UP node 706 and the DU 704 can be serving the device by performing or facilitating performing downlink data transfers of downlink data to the device from a data source (e.g., a service and/or another device, or a network component of the communication network 102 or core network 104 (e.g., via the UPF node)), and uplink data transfers of uplink data from the device to a desired destination (e.g., the data source) via the base station 700.

The base station 700 can receive and transmit signal(s) from and to wireless devices like access points (e.g., base stations, femtocells, picocells, or other type of access point), access terminals (e.g., UEs), wireless ports and routers, and the like, through a set of antennas 769₁-769_{R}. In an aspect, the antennas 769₁-769_{R} can be a part of a communication platform 708, which comprises electronic components and associated circuitry that can provide for processing and manipulation of received signal(s) and signal(s) to be transmitted. In an aspect, the communication platform 708 can include a receiver/transmitter 710 that can convert signal from analog to digital upon reception, and from digital to analog upon transmission. In addition, receiver/transmitter 710 can divide a single data stream into multiple, parallel data streams, or perform the reciprocal operation. In accordance with various embodiments, the communication platform 708 can be, can comprise, or can be associated with an RU (e.g., a gNB or other NR-NB RU node).

In an aspect, coupled to receiver/transmitter 710 can be a multiplexer/demultiplexer (mux/demux) 712 that can facilitate manipulation of signal in time and frequency space. The mux/demux 712 can multiplex information (e.g., data/traffic and control/signaling) according to various multiplexing schemes such as, for example, time division multiplexing (TDM), frequency division multiplexing (FDM), orthogonal frequency division multiplexing (OFDM), code division multiplexing (CDM), space division multiplexing (SDM), etc. In addition, mux/demux component 712 can scramble and spread information (e.g., codes) according to substantially any code known in the art, e.g., Hadamard-Walsh codes, Baker codes, Kasami codes, polyphase codes, and so on. A modulator/demodulator (mod/demod) 714 also can be part of the communication platform 708, and can modulate information according to multiple modulation techniques, such as frequency modulation, amplitude modulation (e.g., M-ary quadrature amplitude modulation (QAM), with M a positive integer), phase-shift keying (PSK), and the like.

The base station 700 also can comprise a processor(s) 716 that can be configured to confer and/or facilitate providing functionality, at least partially, to substantially any electronic component in or associated with the base station 700. For instance, the processor(s) 716 can facilitate operations on data (e.g., symbols, bits, or chips) for multiplexing/demultiplexing, modulation/demodulation, such as effecting direct and inverse fast Fourier transforms, selection of modulation rates, selection of data packet formats, inter-packet times, and/or other operations on data.

In another aspect, the base station 700 can include a data store 718 that can store data structures; code instructions; rate coding information; information relating to measurement of radio link quality or reception of information related thereto; information relating to devices, communication conditions or performance indicators associated with devices (e.g., signal-to-interference-plus-noise ratio (SINR), reference signal received power (RSRP), reference signal received quality (RSRQ), channel quality indicator (CQI), and/or other wireless communications metrics or parameters) associated with devices; information relating to data, files, services, applications, RANs, cells, communication network, core network, devices, users, data traffic, communication sessions, BSRs, BSR indicators, buffer status index values, LCGs, enhanced BSR protocols, uplink grants and allocations, condition or measurement reports, AI/ML-based models, AI-related data, training data, feedback information, predictions, inferences, threshold values, weight values, data processing operations, messages, notifications, alarms, alerts, preferences (e.g., user or client preferences), hash values, metadata, parameters, hyperparameters, traffic flows, tables, mappings, policies, the defined communication management criteria, algorithms (e.g., enhanced communication management algorithms, enhanced BSR management algorithms, AI algorithms, hash algorithms, data compression algorithms, data decompression algorithms, and/or other algorithm), interfaces, protocols, tools, and/or other information; white list information, information relating to managing or maintaining the white list; system or device information like policies and specifications; code sequences for scrambling; spreading and pilot transmission; floor plan configuration; base station deployment and frequency plans; scheduling policies; and so on.

The processor(s) 716 can employ one or more processors (e.g., one or more CPUs, accelerators, GPUs, ASICs, or other processors), microprocessors, or controllers) that can process information, and can be coupled to the data store 718 in order to store and retrieve at least some of the information (e.g., information, such as algorithms, relating to multiplexing/demultiplexing or modulation/demodulation; information relating to radio link levels; information relating to data, files, services, applications, RANs, cells, communication network, core network, devices, users, data traffic, communication sessions, BSRs, BSR indicators, buffer status index values, LCGs, enhanced BSR protocols, uplink grants and allocations, condition or measurement reports, AI/ML-based models, AI-related data, training data, feedback information, predictions, inferences, threshold values, weight values, data processing operations, messages, notifications, alarms, alerts, preferences (e.g., user or client preferences), hash values, metadata, parameters, hyperparameters, traffic flows, tables, mappings, policies, the defined communication management criteria, algorithms (e.g., enhanced communication management algorithms, enhanced BSR management algorithms, AI algorithms, hash algorithms, data compression algorithms, data decompression algorithms, and/or other algorithm), interfaces, protocols, tools, and/or other information) desired to operate and/or confer functionality to the communication platform 708 and/or other operational components of the base station 700. The data store 718 can comprise volatile memory and/or nonvolatile memory, such as described herein.

In accordance with various embodiments, the base station 700 can comprise the communication manager component 720 that can be part of or can be associated with the DU 704 and/or other components of the RAN. The communication manager component 720 can comprise various components and functions, and can perform various operations, such as described herein. In certain embodiments, the communication manager component 720 can desirably manage and perform, or facilitate performance of, uplink grant allocations, and instructing, requesting, or notifying devices to communicate BSRs (e.g., dynamic or on-demand BSRs), in accordance with the defined communication management criteria and the enhanced BSR protocols, such as described herein.

With further regard to the data stores and memory disclosed herein, the data store (e.g., 650 or 718) or memory can comprise volatile memory and/or nonvolatile memory. By way of example and not limitation, nonvolatile memory can include read only memory (ROM), programmable ROM (PROM), electrically programmable ROM (EPROM), electrically erasable ROM (EEPROM), flash memory, non-volatile memory express (NVMe), NVMe over fabric (NVMe-oF), persistent memory (PMEM), or PMEM-oF. Volatile memory can include random access memory (RAM), which can act as external cache memory. By way of example and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects is intended to comprise, without being limited to, these and other suitable types of memory.

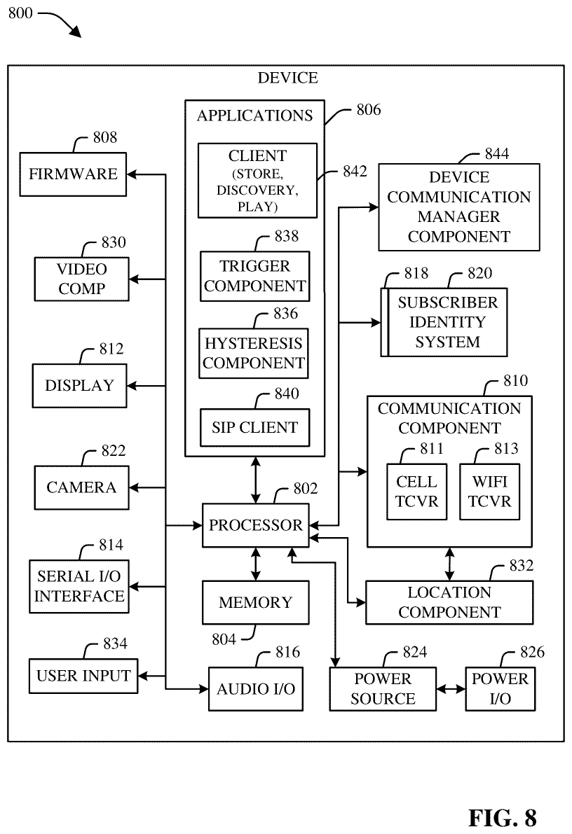

Referring to FIG. 8, FIG. 8 illustrates a diagram of a non-limiting example device 800 (e.g., wireless or mobile phone, electronic pad or tablet, electronic eyewear, electronic watch, other electronic bodywear, IoT device, or other type of communication device or UE) that can be operable to engage in a system architecture that facilitates wireless communications according to one or more embodiments described herein, in accordance with various aspects and embodiments of the disclosed subject matter. Although a device is illustrated herein, it will be understood that other devices can be a communication device, and that the device 800 is merely illustrated to provide context for the embodiments of the various embodiments described herein. The following discussion is intended to provide a brief, general description of an example of a suitable environment in which the various embodiments can be implemented. While the description includes a general context of computer-executable instructions embodied on a machine-readable storage medium, those skilled in the art will recognize that the disclosed subject matter also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device, such as the device 800, can typically include a variety of machine-readable media. Machine-readable media can be any available media that can be accessed by the computer and include both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules, or other data. Computer storage media can include, but is not limited to, RAM, ROM, EEPROM, flash memory or other memory technology, solid state drive (SSD) or other solid-state storage technology, Compact Disk Read Only Memory (CD ROM), digital video disk (DVD), Blu-ray disk, or other optical disk storage, magnetic cassettes, magnetic tape, magnetic disk storage or other magnetic storage devices, or any other medium which can be used to store the desired information and which can be accessed by the computer. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Communication media typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of the any of the above should also be included within the scope of computer-readable media.

The device 800 can include a processor(s) 802 for controlling and processing all onboard operations and functions. The processor(s) 802 can comprise one or more processors (e.g., one or more CPUs, accelerators, GPUs, ASICs, or other processors), microprocessors, or controllers) that can process information associated with the device 800. A memory 804 can interface to the processor(s) 802 for storage of data and one or more applications 806 (e.g., a video player software, user feedback component software, or other application). Other applications can include voice recognition of predetermined voice commands that facilitate initiation of the user feedback signals. Still other applications can comprise an AI application. The applications 806 can be stored in the memory 804 and/or in a firmware 808, and executed by the processor(s) 802 from either or both the memory 804 or/and the firmware 808. The firmware 808 can also store startup code for execution in initializing the device 800. A communication component 810 interfaces to the processor(s) 802 to facilitate wired/wireless communication with external systems, e.g., cellular networks, VoIP networks, and so on. Here, the communication component 810 can also include a suitable cellular transceiver 811 (e.g., a global system for mobile communication (GSM), orthogonal frequency division multiple access (OFDMA), 4G, LTE, 5G, other NR, or other type of transceiver) and/or an unlicensed transceiver 813 (e.g., Wi-Fi, WiMax) for corresponding signal communications. The device 800 can be a device such as a cellular telephone, a PDA with mobile communications capabilities, and messaging-centric devices. The communication component 810 also facilitates communications reception from terrestrial radio networks (e.g., broadcast), digital satellite radio networks, and Internet-based radio services networks.

The device 800 includes a display 812 for displaying text, images, video, telephony functions (e.g., a Caller ID function), setup functions, and for user input. For example, the display 812 can also be referred to as a “screen” that can accommodate the presentation of multimedia content (e.g., music metadata, messages, wallpaper, graphics, etc.). The display 812 can also display videos and can facilitate the generation, editing and sharing of video quotes. A serial I/O interface 814 is provided in communication with the processor(s) 802 to facilitate wired and/or wireless serial communications (e.g., USB, and/or IEEE 1394) through a hardwire connection, and other serial input devices (e.g., a keyboard, keypad, and mouse). This supports updating and troubleshooting the device 800, for example. Audio capabilities are provided with an audio I/O component 816, which can include a speaker for the output of audio signals related to, for example, indication that the user pressed the proper key or key combination to initiate the user feedback signal. The audio I/O component 816 also facilitates the input of audio signals through a microphone to record data and/or telephony voice data, and for inputting voice signals for telephone conversations.

The device 800 can include a slot interface 818 for accommodating a SIC (Subscriber Identity Component) in the form factor of a card Subscriber Identity Module (SIM) or universal SIM 820, and interfacing the SIM card 820 with the processor(s) 802. However, it is to be appreciated that the SIM card 820 can be manufactured into the device 800, and updated by downloading data and software.

The device 800 can process IP data traffic through the communication component 810 to accommodate IP traffic from an IP network such as, for example, the Internet, a corporate intranet, a home network, a person area network, etc., through an ISP or broadband cable provider. Thus, VoIP traffic can be utilized by the device 800 and IP-based multimedia content can be received in either an encoded or a decoded format.

A video processing component 822 (e.g., a camera) can be provided for decoding encoded multimedia content. The video processing component 822 can aid in facilitating the generation, editing, and sharing of video quotes. The device 800 also includes a power source 824 in the form of batteries and/or an AC power subsystem, which power source 824 can interface to an external power system or charging equipment (not shown) by a power I/O component 826.

The device 800 can also include a video component 830 for processing video content received and, for recording and transmitting video content. For example, the video component 830 can facilitate the generation, editing and sharing of video quotes. A location tracking component 832 facilitates geographically locating the device 800. As described hereinabove, this can occur when the user initiates the feedback signal automatically or manually. A user input component 834 facilitates the user initiating the quality feedback signal. The user input component 834 can also facilitate the generation, editing and sharing of video quotes. The user input component 834 can include such conventional input device technologies such as a keypad, keyboard, mouse, stylus pen, and/or touch screen, for example.

Referring again to the applications 806, a hysteresis component 836 facilitates the analysis and processing of hysteresis data, which is utilized to determine when to associate with the access point. A software trigger component 838 can be provided that facilitates triggering of the hysteresis component 836 when the Wi-Fi transceiver 813 detects the beacon of the access point. A SIP client 840 enables the device 800 to support SIP protocols and register the subscriber with the SIP registrar server. The applications 806 can also include a client 842 that provides at least the capability of discovery, play and storage of multimedia content, for example, music.

The device 800, as indicated above related to the communication component 810, includes an indoor network radio transceiver 813 (e.g., Wi-Fi transceiver). This function supports the indoor radio link, such as IEEE 802.11, for the dual-mode GSM device (e.g., device 800). The device 800 can accommodate at least satellite radio services through a device (e.g., handset device) that can combine wireless voice and digital radio chipsets into a single device (e.g., single handheld device).

In some embodiments, the device 800 can comprise the device communication manager component 844 desirably (e.g., automatically, dynamically, suitably, reliably, efficiently, enhancedly, and/or optimally) can manage and perform communication of BSRs (e.g., dynamic or on-demand BSRs) to the base station (e.g., DU of the base station) associated with the device 800. For instance, the device communication manager component 844 can determine whether the device is to communicate a BSR (e.g., a dynamic or on-demand BSR) associated with a particular LCG and the device 800 to the base station based at least in part on the result of an analysis of a BSR indicator, which can be included in a message (e.g., uplink DCI message comprising an uplink grant) received by the device 800 from the base station (e.g., in accordance with the enhanced BSR protocol), such as described herein. For example, if, based at least in part on the analysis results, the device communication manager component 844 determines that the BSR indicator is set to a send-report value (e.g., dynamic or on-demand BSR=true), the device communication manager component 844 can determine that the device is to communicate the BSR report associated with the particular LCG and the device 800 to the base station, in accordance with the defined communication management criteria and the enhanced BSR protocol, such as described herein. If, instead, based at least in part on the analysis results, the device communication manager component 844 determines that the BSR indicator is set to a no-report value (e.g., dynamic or on-demand BSR=false), the device communication manager component 844 can determine that the device 800 is not to communicate the BSR report associated with the particular LCG and the device 800 to the base station, in accordance with the defined communication management criteria and the enhanced BSR protocol, such as described herein.

It is to be appreciated and understood that one or more components (e.g., the devices, configuration manager component, base station, core network, or other component) of the systems (e.g., system 100, system 600, or other system) or methods described herein can comprise or be associated with various other types of components, such as display screens (e.g., touch screen displays or non-touch screen displays), audio functions (e.g., amplifiers, speakers, or audio interfaces), or other interfaces, to facilitate presentation of information to users, entities, or other components (e.g., other devices or other servers), and/or to perform other desired functions or operations.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

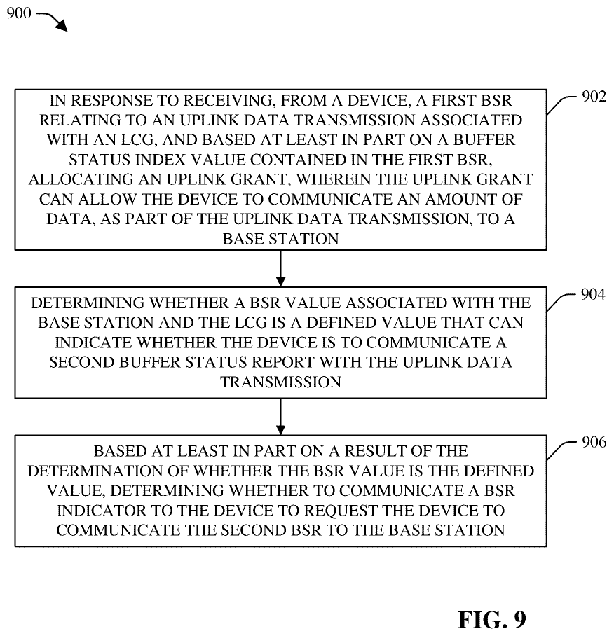

In view of the example systems and/or devices described herein, example methods that can be implemented in accordance with the disclosed subject matter can be further appreciated with reference to flowcharts in FIGS. 9-13. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 9 illustrates a flow chart of an example method 900 that can desirably (e.g., automatically, dynamically, suitably, reliably, efficiently, enhancedly, and/or optimally) manage and perform, or facilitate performance of, instructing, requesting, or notifying a device to communicate BSRs (e.g., dynamic or on-demand BSRs) to a base station, in accordance with various aspects and embodiments of the disclosed subject matter. The method 900 can be employed by, for example, a system comprising the base station and the communication manager component that can comprise or be associated with the processor component, the data store, and/or other components.

At 902, in response to receiving, from a device, a first BSR relating to an uplink data transmission associated with an LCG, and based at least in part on a buffer status index value contained in the first BSR, an uplink grant can be allocated, wherein the uplink grant can allow the device to communicate an amount of data, as part of the uplink data transmission, to a base station. The communication manager can receive, from the device, the first BSR relating to the uplink data transmission associated with the LCG and the device. The first BSR can comprise the buffer status index value, which can indicate or correspond to a certain amount of data associated with the LCG that the device has available (e.g., stored in its buffer component) for transmission, as part of the uplink transmission, to the base station. Based at least in part on the buffer status index value contained in the first BSR, the communication manager (e.g., employing the grant allocator component) can allocate the uplink grant, which can allow the device to communicate the amount of data, as part of the uplink data transmission, to the base station, wherein the amount of data allowed by the uplink grant usually can be sufficient to allow the device to communicate at least the certain amount of data to the base station as part of the uplink transmission (e.g., the certain amount of data available for transmission usually can be less than or equal to the amount of data allowed by the uplink grant).

At 904, a determination can be made regarding whether a BSR value associated with the base station and the LCG is a defined value that can indicate whether the device is to communicate a second buffer status report with the uplink data transmission. The communication manager can determine whether the BSR value associated with the base station and the LCG is the defined value (e.g., 0 bytes or a value that can correspond to 0 bytes) based at least in part on analyzing or inspecting the base station-BSR associated with the base station and the LCG.

At 906, based at least in part on a result of the determination of whether the BSR value is the defined value, a determination can be made regarding whether to communicate a BSR indicator to the device to request the device to communicate the second BSR to the base station. Based at least in part on the result of the determination of whether the BSR value is the defined value and/or other information (e.g., the buffer status index value received from the device, or the previous BSR value associated with the base station and the LCG), the communication manager can determine whether to communicate the particular BSR indicator (e.g., BSR indicator with a send-report indicator value) to the device to request or instruct the device to communicate the second BSR to the base station. For instance, if the communication manager determines that the BSR value associated with the base station and the LCG is the defined value (and/or determines that the buffer status index value received from the device corresponds to a non-zero number of bytes, or the previous (e.g., immediately previous) BSR value associated with the base station and the LCG corresponds to a non-zero number of bytes), the communication manager can determine that the particular BSR indicator (e.g., BSR indicator with a send-report indicator value) is to be communicated to the device to request or instruct the device to communicate the second BSR to the base station, such as described herein. If, instead, the communication manager determines that the BSR value associated with the base station and the LCG is not the defined value (and/or determines that the buffer status index value received from the device corresponds to a zero number of bytes, or the previous BSR value associated with the base station and the LCG corresponds to a zero number of bytes), the communication manager can determine that the different BSR indicator (e.g., BSR indicator with a no-report indicator value) is to be communicated to the device to indicate to the device that the device is not to communicate a second BSR to the base station, such as described herein.

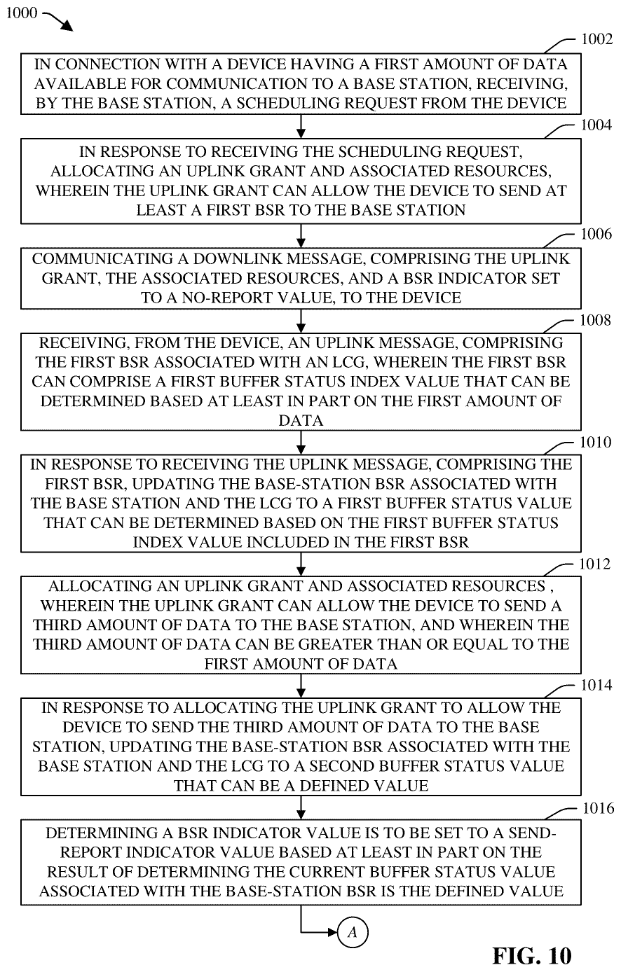

FIGS. 10-12 depict a flow chart of another example method 1000 that can desirably (e.g., automatically, dynamically, suitably, reliably, efficiently, enhancedly, and/or optimally) manage and perform, or facilitate performance of, instructing, requesting, or notifying a device to communicate BSRs (e.g., dynamic or on-demand BSRs) to a base station, in accordance with various aspects and embodiments of the disclosed subject matter. The method 1000 can be employed by, for example, a system comprising the base station and the communication manager component that can comprise or be associated with the processor component, the data store, and/or other components.

At 1002, in connection with a device having a first amount of data available for communication to a base station, the base station can receive a scheduling request from the device. At 1004, in response to receiving the scheduling request, an uplink grant and associated resources can be allocated, wherein the uplink grant can allow the device to send at least a first BSR to the base station. For instance, the base station (e.g., the DU of the base station) can comprise or be associated with the communication manager component, and the communication manager component (e.g., employing the grant allocator component) can allocate the uplink grant and associated resources for the device to allow the device to send at least the first BSR to the base station.

At 1006, a downlink message, comprising the uplink grant, the associated resources, and a BSR indicator set to a no-report value, can be communicated to the device. The communication manager component can set the BSR indicator to the no-report value, which can indicate that the device is not being requested to send a dynamic BSR (e.g., on-demand BSR), since the device is already being allocated the uplink grant and associated resources to send a regular BSR (e.g., the first BSR) to the base station. The communication manager component can communicate or facilitate communicating the message (e.g., uplink DCI message), comprising the uplink grant, associated resources, and BSR indicator set to the no-report value, from the base station to the device.

At 1008, an uplink message, comprising the first BSR associated with an LCG can be received from the device, wherein the first BSR can comprise a first buffer status index value, and wherein the first buffer status index value can be determined based at least in part on the first amount of data. For instance, the base station can receive the uplink message (e.g., uplink MAC message), including the first BSR associated with the LCG, from the device, in accordance with the uplink grant (e.g., first uplink grant).

After the device has communicated the first BSR to the base station, the device can initiate (e.g., start or restart) the periodic BSR timer and retx BSR timer, such as described herein. In some instances, subsequent to sending the first BSR, and initiating the periodic BSR timer and retx BSR timer, the device can have a second amount of data associated with the LCG that can become available for transmission to the base station (e.g., second amount of data available and stored in the buffer component of the device). However, the base station typically may not be aware that the second amount of data is available for transmission at the device, since the first BSR was communicated to the base station prior to the second amount of data becoming available for transmission at the device.

At 1010, in response to receiving the uplink message, comprising the first BSR, the base-station BSR associated with the base station and the LCG can be updated to a first buffer status value that can be determined based at least in part on the first buffer status index value included in the first BSR. The communication manager component (e.g., of or associated with the DU of the base station) can determine the first buffer status value for the base-station BSR, and can update the base-station BSR associated with the base station and the LCG to the first buffer status value, based at least in part on the result of analyzing the first BSR, including the first buffer status index value. In accordance with various embodiments, the first buffer status value can correspond to (e.g., can be equal to) the amount of data associated with (e.g., mapped to, corresponding to, or represented by) the first buffer status index value, or can be the same as the first buffer status index value to be representative of such amount of data, wherein the amount of data represented by the first buffer status index value usually can be equal to or greater than the first amount of data available at the device for transmission to the base station.

At 1012, an uplink grant and associated resources can be allocated, wherein the uplink grant can allow the device to send a third amount of data to the base station, and wherein the third amount of data can be greater than or equal to the first amount of data. For instance, the communication manager component (e.g., employing the grant allocator component) can allocate the uplink grant and associated resources for the device to allow the device to send the third amount of data to the base station.

At 1014, in response to allocating the uplink grant to allow the device to send the third amount of data to the base station, the base-station BSR associated with the base station and the LCG can be updated to a second buffer status value, which can be a defined value. For instance, the communication manager component can update the base-station BSR associated with the base station and the LCG to the second buffer status value, which can be the defined value (e.g., 0 bytes or a value that can be representative of 0 bytes).

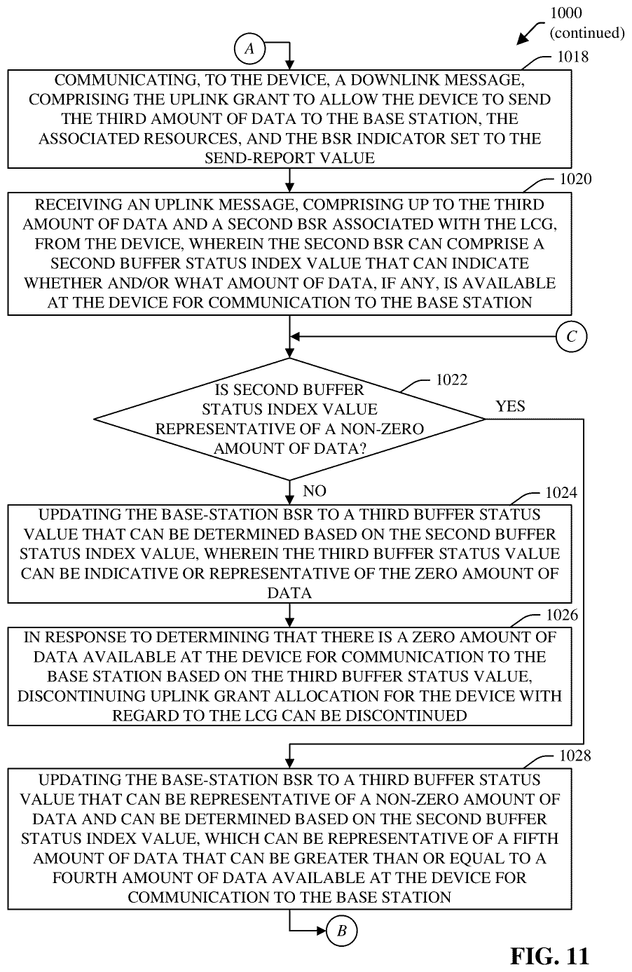

At 1016, a determination can be made that a BSR indicator value is to be set to a send-report indicator value based at least in part on the result of determining that the current buffer status value associated with the base-station BSR is the defined value. In some embodiments, if the communication manager component determines that the current buffer status value associated with the base-station BSR is the defined value, the communication manager component can determine that the BSR indicator value is to be set to the send-report indicator value, which can indicate that the device is to send a BSR to the base station. In certain embodiments, if the communication manager component determines that the current buffer status value associated with the base-station BSR is the defined value and/or determines that the previous buffer status value associated with the base-station BSR was a non-zero value or was representative of a non-zero value, and/or determines that the first buffer status index value is representative of a non-zero value, the communication manager component can determine that the BSR indicator value is to be set to the send-report indicator value. It is noted that, typically at this point (e.g., where the base station has received, from the device, a first BSR, comprising a first buffer status index value (e.g., representative of a non-zero amount of data), in response to a first uplink grant allocated after the base station received a scheduling request from the device), the current buffer status value associated with the base-station BSR can be the defined value after the update. At this point, the method 1000 can proceed to reference point A, wherein, as depicted in FIG. 11 and described herein, the method can proceed from reference point A to reference numeral 1018.

At 1018, a downlink message, comprising the uplink grant to allow the device to send the third amount of data to the base station, the associated resources, and the BSR indicator set to the send-report value, can be communicated to the device. The communication manager component can set the BSR indicator to the send-report value, which can indicate that the device is being instructed or requested to send a dynamic BSR. The communication manager component can communicate or facilitate communicating the message (e.g., uplink DCI message), comprising the uplink grant, associated resources, and BSR indicator set to the send-report value, from the base station to the device.

At 1020, an uplink message, comprising up to the third amount of data and a second BSR associated with the LCG, can be received from the device, wherein the second BSR can comprise a second buffer status index value that can indicate whether and/or what amount of data, if any, is available at the device for communication to the base station. For instance, the base station can receive the uplink message (e.g., uplink MAC message), including up to the third amount of data (e.g., comprising the first amount of data and/or a portion of the second amount of data) and the second BSR associated with the LCG, from the device, in accordance with the uplink grant (e.g., second uplink grant).

At 1022, a determination can be made regarding whether the second buffer status index value is representative of a non-zero amount of data or a zero amount of data available at the device for communication to the base station based at least in part on analyzing the second buffer status index value. For instance, the communication manager component can analyze the second buffer status index value, and based at least in part on the analysis results, the communication manager component can determine whether the second buffer status index value is representative of a non-zero amount of data or a zero amount of data available at the device for communication to the base station.

If it is determined that the second buffer status index value is representative of a zero amount of data, at 1024, the base-station BSR associated with the base station and the LCG can be updated to a third buffer status value that can be determined based at least in part on the second buffer status index value, wherein the third buffer status value can be indicative or representative of the zero amount of data. In some embodiments, the communication manager component can determine the third buffer status value for the base-station BSR, and can update the base-station BSR associated with the base station and the LCG to the third buffer status value, based at least in part on the result of analyzing the second BSR, including the second buffer status index value. For example, if the communication manager component determines that the second buffer status index value is representative of a zero amount of data, the communication manager component can update the third buffer status value of the base-station BSR to a zero value (e.g., representative of 0 bytes).

At 1026, in response to determining that there is a zero amount of data available at the device for communication to the base station based at least in part on the third buffer status value of the base-station BSR, uplink grant allocation for the device with regard to the LCG can be discontinued. In some embodiments, if the communication manager component determines that there is a zero amount of data available at the device for communication to the base station, the communication manager component can discontinue (e.g., suspend or stop) uplink grant allocation for the device with regard to the LCG, at least for now (e.g., if and until the device requests to communicate more data to the base station).

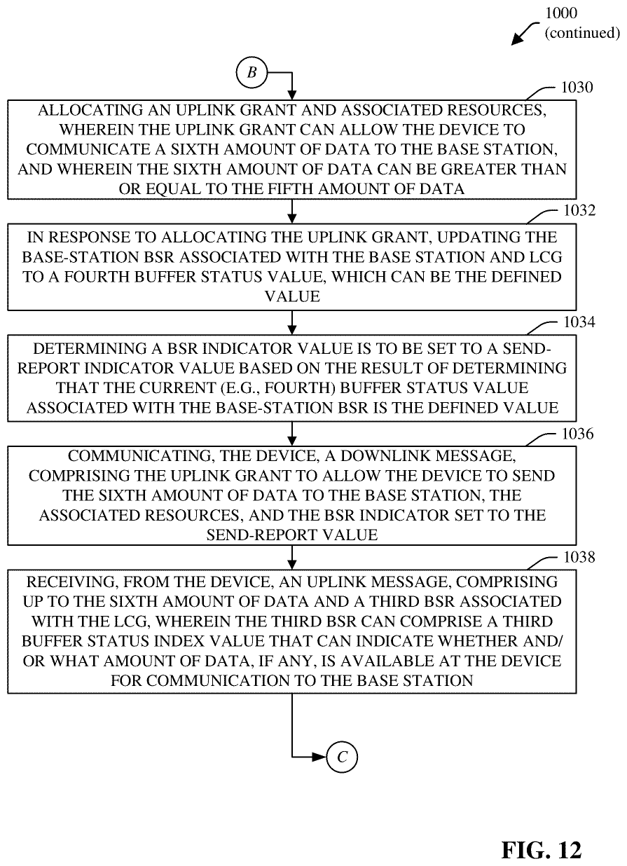

Referring again to reference numeral 1022, if, instead, at 1022, it is determined that the second buffer status index value is representative of the non-zero amount of data, at 1028, the base-station BSR associated with the base station and the LCG can be updated to a third buffer status value that can be representative of a non-zero amount of data and can be determined based at least in part on the second buffer status index value, which can be representative of a fifth amount of data that can be greater than or equal to a fourth amount of data available at the device for communication to the base station. In certain embodiments, the communication manager component can determine the third buffer status value for the base-station BSR, and can update the base-station BSR associated with the base station and the LCG to the third buffer status value, based at least in part on the result of analyzing the second BSR, including the second buffer status index value. In accordance with various embodiments, the third buffer status value can correspond to (e.g., can be equal to) the fifth amount of data associated with (e.g., mapped to, corresponding to, or represented by) the second buffer status index value, or can be the same as the second buffer status index value to be representative of the fifth amount of data, wherein the fifth amount of data represented by the second buffer status index value usually can be equal to or greater than the fourth amount of data available (e.g., in the buffer component) at the device for communication to the base station. At this point, the method 1000 can proceed to reference point B, wherein, as depicted in FIG. 12 and described herein, the method can proceed from reference point B to reference numeral 1030.

At 1030, an uplink grant and associated resources can be allocated, wherein the uplink grant can allow the device to communicate a sixth amount of data to the base station, and wherein the sixth amount of data can be greater than or equal to the fifth amount of data. For instance, the communication manager component (e.g., employing the grant allocator component) can allocate the uplink grant and associated resources for the device to allow the device to send the sixth amount of data to the base station.

At 1032, in response to allocating the uplink grant to allow the device to send the sixth amount of data to the base station, the base-station BSR associated with the base station and the LCG can be updated to a fourth buffer status value, which can be the defined value. For instance, the communication manager component can update the base-station BSR associated with the base station and the LCG to the fourth buffer status value, which can be the defined value (e.g., 0 bytes or a value that can be representative of 0 bytes).

At 1034, a determination can be made that a BSR indicator value is to be set to a send-report indicator value based at least in part on the result of determining that the current (e.g., fourth) buffer status value associated with the base-station BSR is the defined value. In some embodiments, if the communication manager component determines that the current buffer status value associated with the base-station BSR is the defined value, the communication manager component can determine that the BSR indicator value is to be set to the send-report indicator value, which can indicate that the device is to send a BSR to the base station. In certain embodiments, if the communication manager component determines that the current buffer status value associated with the base-station BSR is the defined value and/or determines that the previous (e.g., third) buffer status value associated with the base-station BSR was a non-zero value or was representative of a non-zero value, and/or determines that the second buffer status index value is representative of a non-zero value, the communication manager component can determine that the BSR indicator value is to be set to the send-report indicator value.

At 1036, a downlink message, comprising the uplink grant to allow the device to send the sixth amount of data to the base station, the associated resources, and the BSR indicator set to the send-report value, can be communicated to the device. The communication manager component can set the BSR indicator to the send-report value, which can indicate that the device is being instructed or requested to send a dynamic BSR. The communication manager component can communicate or facilitate communicating the message (e.g., uplink DCI message), comprising the uplink grant, associated resources, and BSR indicator set to the send-report value, from the base station to the device.

At 1038, an uplink message, comprising up to the sixth amount of data and a third BSR associated with the LCG, can be received from the device, wherein the third BSR can comprise a third buffer status index value that can indicate whether and/or what amount of data, if any, is available at the device for communication to the base station. For instance, the base station can receive the uplink message, including up to the sixth amount of data (e.g., comprising the fourth amount of data and/or another amount of data that can total up to the sixth amount of data) and the third BSR associated with the LCG, from the device, in accordance with the uplink grant (e.g., third uplink grant).

In some embodiments, at this point, the method 1000 can proceed to reference point C, wherein, as presented in FIG. 11, the method can proceed from reference point C to reference numeral 1022 where the third buffer status index value can be analyzed to determine whether the third buffer status index value is representative of a non-zero amount of data or a zero amount of data available at the device for communication to the base station, and the method 1000 can proceed from that point, such as described herein, for example, until it is determined (e.g., by the communication manager component) that a particular buffer status index value of a particular BSR can be representative of a zero amount of data available at the device for communication to the base station, and uplink grant allocation for the device with regard to the LCG can be discontinued. It is to be appreciated and understood that, after the method 1000 proceeds back from reference numeral 1038 to reference numeral 1022 (e.g., via reference point C), some of the number-related terms (e.g., second buffer status index value, third buffer status value, fifth amount of data, and other terms) can have different numerical indicators or values as the method 1000 progresses.

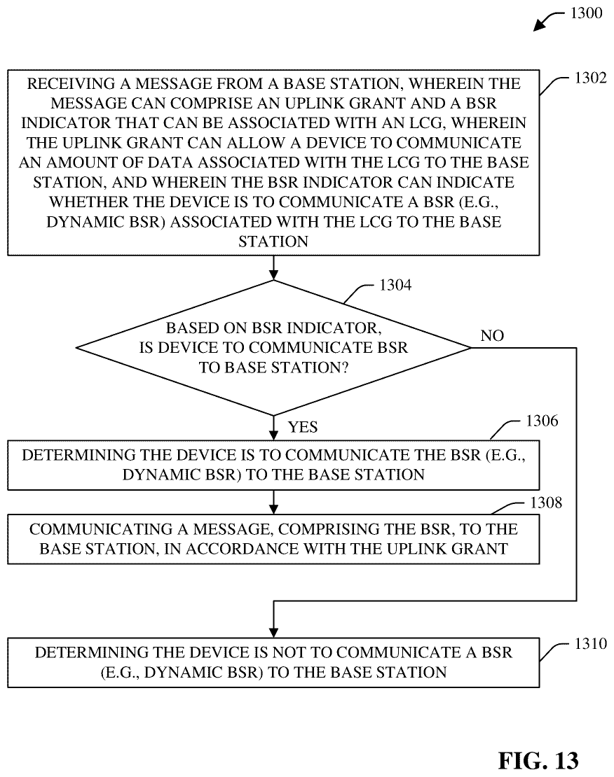

FIG. 13 depicts a flow chart of another example method 1300 that can desirably (e.g., automatically, dynamically, suitably, reliably, efficiently, enhancedly, and/or optimally) manage and perform, or facilitate performance of, communication of BSRs (e.g., dynamic or on-demand BSRs) by a device to a base station, in accordance with various aspects and embodiments of the disclosed subject matter. The method 1300 can be employed by, for example, a system comprising the device and the device communication manager component that can comprise or be associated with the processor component, the data store, and/or other components.

At 1302, a message can be received from a base station, wherein the message can comprise an uplink grant and a BSR indicator that can be associated with an LCG, wherein the uplink grant can allow a device to communicate an amount of data associated with the LCG to the base station, and wherein the BSR indicator can indicate whether the device is to communicate a BSR (e.g., dynamic BSR) associated with the LCG to the base station. For instance, the device can receive a message (e.g., an uplink DCI message) from the base station, wherein the message can comprise the uplink grant and the BSR indicator that can be associated with the LCG associated with the device. The uplink grant can allow the device to communicate the amount of data associated with the LCG to the base station. The uplink grant can be in response to a previous BSR, comprising a previous buffer status index value, that the device sent to the base station, for example. The BSR indicator can indicate whether the device is to communicate a BSR associated with the LCG to the base station.

At 1304, a determination can be made regarding whether the device is to communicate the BSR to the base station based at least in part on the BSR indicator. For instance, the device, employing the device communication manager, can determine whether the device is to communicate the BSR (e.g., dynamic BSR) to the base station based at least in part on the result of analyzing the BSR indicator contained in the message.

If, based at least in part on the BSR indicator, it is determined that the BSR indicator is a send-report value, at 1306, a determination can be made that the device is to communicate the BSR (e.g., dynamic BSR) to the base station. At 1308, a message, comprising the BSR, can be communicated to the base station, in accordance with the uplink grant. For instance, if, based at least in part on the result of analyzing the BSR indicator, the device communication manager determines that the BSR indicator is the send-report value, the device communication manager can determine that the device is to communicate the BSR to the base station, and the device can communicate the BSR, in accordance with the uplink grant, such as described herein.

Referring again to reference numeral 1304, if, instead, based at least in part on the BSR indicator, it is determined that the BSR indicator is a no-report value, at 1310, a determination can be made that the device is not to communicate a BSR (e.g., dynamic BSR) to the base station. For instance, if, instead, based at least in part on the result of analyzing the BSR indicator, the device communication manager determines that the BSR indicator is the no-report value, the device communication manager can determine that the device is not to communicate a BSR to the base station, and the device may not communicate a BSR (e.g., dynamic BSR) to the base station, such as described herein.

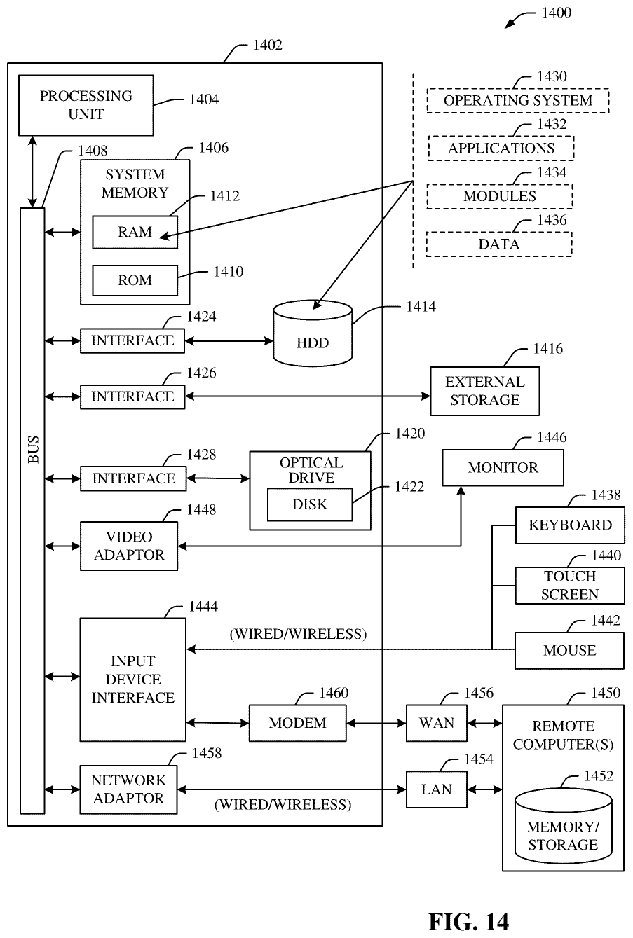

In order to provide additional context for various embodiments described herein, FIG. 14 and the following discussion are intended to provide a brief, general description of a suitable computing environment 1400 in which the various embodiments of the embodiments described herein can be implemented. While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and include any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the example environment 1400 for implementing various embodiments of the aspects described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes ROM 1410 and RAM 1412. A basic input/output system (BIOS) can be stored in a non-volatile memory such as ROM, erasable programmable read only memory (EPROM), EEPROM, which BIOS contains the basic routines that help to transfer information between elements within the computer 1402, such as during startup. The RAM 1412 can also include a high-speed RAM such as static RAM for caching data.

The computer 1402 further includes an internal hard disk drive (HDD) 1414 (e.g., EIDE, SATA), one or more external storage devices 1416 (e.g., a magnetic floppy disk drive (FDD) 1416, a memory stick or flash drive reader, a memory card reader, etc.) and an optical disk drive 1420 (e.g., which can read or write from a CD-ROM disc, a DVD, a BD, etc.). While the internal HDD 1414 is illustrated as located within the computer 1402, the internal HDD 1414 also can be configured for external use in a suitable chassis (not shown). Additionally, while not shown in environment 1400, a solid state drive (SSD) could be used in addition to, or in place of, an HDD 1414. The HDD 1414, external storage device(s) 1416 and optical disk drive 1420 can be connected to the system bus 1408 by an HDD interface 1424, an external storage interface 1426 and an optical drive interface 1428, respectively. The interface 1424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. The systems and methods described herein can be implemented utilizing various commercially available operating systems or combinations of operating systems.

Computer 1402 can optionally comprise emulation technologies. For example, a hypervisor (not shown) or other intermediary can emulate a hardware environment for operating system 1430, and the emulated hardware can optionally be different from the hardware illustrated in FIG. 14. In such an embodiment, operating system 1430 can comprise one virtual machine (VM) of multiple VMs hosted at computer 1402. Furthermore, operating system 1430 can provide runtime environments, such as the Java runtime environment or the .NET framework, for applications 1432. Runtime environments are consistent execution environments that allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and settings for an application.

Further, computer 1402 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1402, e.g., applied at the application execution level or at the operating system (OS) kernel level, thereby enabling security at any level of code execution.

A user can enter commands and information into the computer 1402 through one or more wired/wireless input devices, e.g., a keyboard 1438, a touch screen 1440, and a pointing device, such as a mouse 1442. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1404 through an input device interface 1444 that can be coupled to the system bus 1408, but can be connected by other interfaces, such as a parallel port, an IEEE 1394 serial port, a game port, a USB port, an IR interface, a BLUETOOTH® interface, etc.

A monitor 1446 or other type of display device can also be connected to the system bus 1408 via an interface, such as a video adapter 1448. In addition to the monitor 1446, a computer typically includes other peripheral output devices (not shown), such as speakers, printers, etc.

The computer 1402 can operate in a networked environment using logical connections via wired and/or wireless communications to one or more remote computers, such as a remote computer(s) 1450. The remote computer(s) 1450 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1452 is illustrated. The logical connections depicted include wired/wireless connectivity to a local area network (LAN) 1454 and/or larger networks, e.g., a wide area network (WAN) 1456. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1454 through a wired and/or wireless communication network interface or adapter 1458. The adapter 1458 can facilitate wired or wireless communication to the LAN 1454, which can also include a wireless access point (AP) disposed thereon for communicating with the adapter 1458 in a wireless mode.

When used in a WAN networking environment, the computer 1402 can include a modem 1460 or can be connected to a communications server on the WAN 1456 via other means for establishing communications over the WAN 1456, such as by way of the Internet. The modem 1460, which can be internal or external and a wired or wireless device, can be connected to the system bus 1408 via the input device interface 1444. In a networked environment, program modules depicted relative to the computer 1402 or portions thereof, can be stored in the remote memory/storage device 1452. It will be appreciated that the network connections shown are examples and other means of establishing a communications link between the computers can be used.

When used in either a LAN or WAN networking environment, the computer 1402 can access cloud storage systems or other network-based storage systems in addition to, or in place of, external storage devices 1416 as described above. Generally, a connection between the computer 1402 and a cloud storage system can be established over a LAN 1454 or WAN 1456, e.g., by the adapter 1458 or modem 1460, respectively. Upon connecting the computer 1402 to an associated cloud storage system, the external storage interface 1426 can, with the aid of the adapter 1458 and/or modem 1460, manage storage provided by the cloud storage system as it would other types of external storage. For instance, the external storage interface 1426 can be configured to provide access to cloud storage sources as if those sources were physically connected to the computer 1402.

The computer 1402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer-readable storage media can include but are not limited to magnetic storage devices (e.g., hard disk, floppy disk, magnetic strips, etc.), optical discs (e.g., compact disc (CD), digital versatile disc (DVD), blu-ray disc (BD), etc.), smart cards, and memory devices comprising volatile memory and/or non-volatile memory (e.g., flash memory devices, such as, for example, card, stick, key drive, etc.), or the like. In accordance with various implementations, computer-readable storage media can be non-transitory computer-readable storage media and/or a computer-readable storage device can comprise computer-readable storage media.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. A processor can be or can comprise, for example, multiple processors that can include distributed processors or parallel processors in a single machine or multiple machines. Additionally, a processor can comprise or refer to an integrated circuit, an application specific integrated circuit (ASIC), a digital signal processor (DSP), a programmable gate array (PGA), a field programmable gate array (FPGA), a programmable logic controller (PLC), a complex programmable logic device (CPLD), a state machine, a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

A processor can facilitate performing various types of operations, for example, by executing computer-executable instructions. When a processor executes instructions to perform operations, this can include the processor performing (e.g., directly performing) the operations and/or the processor indirectly performing operations, for example, by facilitating (e.g., facilitating operation of), directing, controlling, or cooperating with one or more other devices or components to perform the operations. In some implementations, a memory can store computer-executable instructions, and a processor can be communicatively coupled to the memory, wherein the processor can access or retrieve computer-executable instructions from the memory and can facilitate execution of the computer-executable instructions to perform operations.

In certain implementations, a processor can be or can comprise one or more processors that can be utilized in supporting a virtualized computing environment or virtualized processing environment. The virtualized computing environment may support one or more virtual machines representing computers, servers, or other computing devices. In such virtualized virtual machines, components such as processors and storage devices may be virtualized or logically represented.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

As used in this application, the terms “component,” “system,” “platform,” “framework,” “layer,” “interface,” “agent,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, computer-executable instructions, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

A communication device, such as described herein, can be or can comprise, for example, a computer, a laptop computer, a server, a phone (e.g., a smart phone), an electronic pad or tablet, an electronic gaming device, electronic headwear or bodywear (e.g., electronic eyeglasses, smart watch, augmented reality (AR)/virtual reality (VR) headset, or other type of electronic headwear or bodywear), a set-top box, an Internet Protocol (IP) television (IPTV), IoT device (e.g., medical device, electronic speaker with voice controller, camera device, security device, tracking device, appliance, or other IoT device), or other desired type of communication device.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

It is to be appreciated and understood that components (e.g., device, UE, communication network, core network, RAN, base station, communication manager component, device communication manager component, processor component, data store, or other component), as described with regard to a particular system or method, can include the same or similar functionality as respective components (e.g., respectively named components or similarly named components) as described with regard to other systems or methods disclosed herein.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A method, comprising:
in response to receiving, from a device, a first buffer status report relating to an uplink data transmission associated with a logical channel group, and based on a buffer status index value contained in the first buffer status report, allocating, by a system comprising at least one processor, an uplink grant that allows the device to communicate an amount of data, as part of the uplink data transmission, to a base station;
determining, by the system, whether a buffer status report value associated with the base station and the logical channel group is a defined value that indicates whether the device is to communicate a second buffer status report with the uplink data transmission; and
based on a result of the determining of whether the buffer status report value is the defined value, determining, by the system, whether to communicate a buffer status report indicator to the device to request the device to communicate the second buffer status report to the base station.

2. The method of claim 1, wherein the amount of data is a first amount of data, wherein the buffer status report value is a second buffer status report value, wherein the buffer status index value corresponds to a second amount of data that is equal to or less than the first amount of data, wherein a first buffer status report value is determined based on the buffer status index value, wherein, at a time of communicating the first buffer status report, the device had a third amount of data available for communication to the base station that was equal to or less than the second amount of data, and wherein the method further comprises:
in connection with the allocating of the uplink grant, updating, by the system, the first buffer status report value associated with the base station and the logical channel group to the second buffer status report value that is the defined value; and
based on the result indicating that the buffer status report value is the defined value, communicating, by the system, a message, comprising the uplink grant and the buffer status report indicator, to the device, wherein the buffer status report indicator indicates that the device is to communicate the second buffer status report to the base station.

3. The method of claim 2, wherein the buffer status index value is a first buffer status index value, and wherein the method further comprises:
receiving, by the system, the uplink data transmission, comprising at least the third amount of data and the second buffer status report relating to the logical channel group, from the device, in accordance with the uplink grant and the buffer status report indicator, wherein the second buffer status report comprises a second buffer status index value.

4. The method of claim 3, wherein the uplink data transmission is a first uplink data transmission, wherein the uplink grant is a first uplink grant, wherein the message is a first message, wherein, subsequent to the time of the communicating of the first buffer status report, the device has a fourth amount of data that became available for transmission to the base station, wherein a combined amount of the third amount of data and the fourth amount of data is greater than the first amount of data authorized for transmission by the first uplink grant, wherein the second buffer status index value corresponds to a fifth amount of data that is greater than or equal to the fourth amount of data and indicates that up to the fifth amount of data is available for transmission to the base station, wherein the buffer status report indicator is a first buffer status report indicator, and wherein the method further comprises:
based on the second buffer status index value, updating, by the system, the second buffer status report value associated with the base station and the logical channel group to a third buffer status report value that indicates the device has up to the fifth amount of data available for transmission to the base station; and
communicating, by the system, a second message, comprising a second uplink grant and a second buffer status report indicator, to the device to allow the device to communicate up to the fifth amount of data, comprising the fourth amount of data, as part of a second uplink data transmission, to the base station, wherein the second buffer status report indicator indicates that the device is to communicate a third buffer status report to the base station.

5. The method of claim 3, wherein the second buffer status index value indicates that the device does not have any additional data available for communication to the base station, and wherein the method further comprises:
based on determining that the second buffer status index value indicates that the device does not have any additional data available for communication to the base station:
setting or updating, by the system, a third buffer status report value associated with the base station and the logical channel group to indicate that the device does not have any additional data available for communication to the base station; and
determining, by the system, that uplink resource allocation for the device is to be discontinued or suspended.

6. The method of claim 2, wherein the message is an uplink downlink control information message, wherein the uplink downlink control information message comprises respective items of control-related information contained in respective fields in an uplink downlink control information format, and wherein the respective fields comprise a field that contains the buffer status report indicator.

7. The method of claim 1, wherein the uplink grant is a second uplink grant, and wherein the method further comprises:
receiving, by the system, a scheduling request from the device; and
in response to receiving the scheduling request, communicating, by the system, a first uplink grant to the device, wherein the first uplink grant allows the device to communicate the first buffer status report, comprising the buffer status index value, to the base station.

8. A system, comprising:
at least one memory that stores computer executable components; and
at least one processor that executes computer executable components stored in the at least one memory, wherein the computer executable components comprise:
a grant allocator, wherein, in response to receiving, from a user equipment, a first buffer status report relating to an uplink data transmission associated with a logical channel group, and based on a buffer status index value contained in the first buffer status report, the grant allocator allocates an uplink grant that allows the user equipment to transmit an amount of data, as part of the uplink data transmission, to network equipment; and
a communication manager that makes a determination of whether a buffer status report value associated with the network equipment and the logical channel group is a particular value that indicates whether the user equipment is to transmit a second buffer status report with the uplink data transmission,
wherein, based on a result of the determination of whether the buffer status report value is the defined value, the communication manager further determines whether to transmit a buffer status report indicator to the user equipment to request or instruct the user equipment to transmit the second buffer status report to the network equipment.

9. The system of claim 8, wherein the amount of data is a first amount of data, wherein the buffer status report value is a second buffer status report value, wherein the buffer status index value corresponds to a second amount of data that is equal to or less than the first amount of data, wherein the communication manager determines a first buffer status report value based on the buffer status index value, wherein, at a time of transmission of the first buffer status report, the user equipment had a third amount of data available for transmission to the network equipment that was equal to or less than the second amount of data,
wherein, in connection with the allocation of the uplink grant, the communication manager modifies the first buffer status report value associated with the network equipment and the logical channel group to the second buffer status report value that is the defined value,
wherein, based on the result indicating that the buffer status report value is the defined value, the communication manager determines that the buffer status report indicator is to be set to indicate that the user equipment is to transmit the second buffer status report to the network equipment, and
wherein the communication manager initiates transmission of an uplink downlink control information message, comprising the uplink grant and the buffer status report indicator, to the user equipment.

10. The system of claim 9, wherein the buffer status index value is a first buffer status index value, wherein the network equipment receives the uplink data transmission, comprising at least the third amount of data and the second buffer status report relating to the logical channel group, from the user equipment, in accordance with the uplink grant and the buffer status report indicator, and wherein the second buffer status report comprises a second buffer status index value.

11. The system of claim 10, wherein the uplink data transmission is a first uplink data transmission, wherein the uplink grant is a first uplink grant, wherein the uplink downlink control information message is a first uplink downlink control information message, wherein, subsequent to the time of the transmission of the first buffer status report, the user equipment has a fourth amount of data that became available for transmission to the network equipment, wherein a total amount of the third amount of data and the fourth amount of data is greater than the first amount of data permitted for transmission by the first uplink grant, wherein the second buffer status index value corresponds to a fifth amount of data that is greater than or equal to the fourth amount of data and indicates that up to the fifth amount of data is available for transmission to the network equipment, wherein the buffer status report indicator is a first buffer status report indicator,
wherein, based on the second buffer status index value, the communication manager modifies the second buffer status report value associated with the network equipment and the logical channel group to a third buffer status report value that indicates the user equipment has up to the fifth amount of data available for transmission to the network equipment,
wherein the communication manager initiates transmission of a second uplink downlink control information message, comprising a second uplink grant and a second buffer status report indicator, to the user equipment to allow the user equipment to communicate up to the fifth amount of data, comprising the fourth amount of data, as part of a second uplink data transmission, to the network equipment, and wherein the second buffer status report indicator indicates that the user equipment is to transmit a third buffer status report to the network equipment.

12. The system of claim 10, wherein the second buffer status index value indicates that the user equipment does not have any additional data available for transmission to the network equipment, and
wherein, based on determining that the second buffer status index value indicates that the user equipment does not have any additional data available for transmission to the network equipment, the communication manager sets or updates a third buffer status report value associated with the network equipment and the logical channel group to indicate that the user equipment does not have any additional data available for transmission to the network equipment, and discontinues or initiates discontinuation of uplink resource allocation for the user equipment.

13. The system of claim 8, wherein the communication manager initiates transmission of an uplink downlink control information message, comprising the uplink grant and the buffer status report indicator, to the user equipment, wherein the uplink downlink control information message comprises respective items of information contained in respective fields in an uplink downlink control information format, and wherein the respective fields comprise a field that comprises the buffer status report indicator.

14. The system of claim 8, wherein the uplink grant is a second uplink grant, wherein the network equipment receives a scheduling request from the user equipment, wherein, in response to receiving the scheduling request, the communication manager initiates transmission of a first uplink grant to the user equipment, and wherein the first uplink grant permits the user equipment to transmit the first buffer status report, comprising the buffer status index value, to the network equipment.

15. The system of claim 8, wherein a radio access network comprises a distributed unit that comprises or is associated with the grant allocator and the communication manager.

16. A non-transitory machine-readable medium, comprising executable instructions that, when executed by at least one processor, facilitate performance of operations, comprising:
receiving a message from a base station, wherein the message comprises an uplink grant and a buffer status report indicator that are associated with a logical channel group, wherein the uplink grant allows a device to communicate an amount of data associated with the logical channel group to the base station, and wherein the buffer status report indicator indicates whether the device is to communicate a buffer status report associated with the logical channel group to the base station; and
determining whether the device is to communicate the buffer status report to the base station based on the buffer status report indicator.

17. The non-transitory machine-readable medium of claim 16, wherein the message is a first message, wherein the amount of data is a first amount of data, and wherein the operations further comprise:
determining that the buffer status report indicator has a send-report value based on analyzing the buffer status report indicator;
determining that the device is to communicate the buffer status report to the base station based on determining that the buffer status report indicator has the send-report value that indicates the device is to communicate the buffer status report to the base station; and
communicating a second message, comprising the first amount of data and the buffer status report associated with the logical channel group, to the base station, wherein the buffer status report comprises a buffer status index value that indicates a second amount of data that remains available at the device for communication to the base station.

18. The non-transitory machine-readable medium of claim 17, wherein the buffer status index value indicates the second amount of data that is stored in a buffer memory of the device and remains available at the device for communication to the base station.

19. The non-transitory machine-readable medium of claim 16, wherein the message is a first message, and wherein the operations further comprise:
determining that the buffer status report indicator has a no-report value based on analyzing the buffer status report indicator;
determining that the device is not to communicate the buffer status report to the base station based on determining that the buffer status report indicator has the no-report value that indicates the device is not to communicate the buffer status report to the base station; and
in response to determining that the device is not to communicate the buffer status report to the base station, communicating a second message, comprising the amount of data associated with the logical channel group, to the base station, wherein the second message does not comprise the buffer status report.

20. The non-transitory machine-readable medium of claim 16, wherein the message is an uplink downlink control information message, wherein the uplink downlink control information message comprises respective items of control-related information contained in respective fields in an uplink downlink control information format, and wherein the respective fields comprise a field that contains the buffer status report indicator.
